(19) United States
(12) Patent Application Publication
(10) Pub. No.: US 2026/0140521 A1
(43) Pub. Date: May 21, 2026

(54) FLOW RATE CONTROL SYSTEM AND FLOW RATE CONTROL METHOD

(71) Applicant: NIPPON LIGHT METAL COMPANY, LTD., Tokyo (JP)

(72) Inventors: Kazuma YAMADA, Tokyo (JP); Yuji TAKASHIMA, Osaka (JP); Hiroyuki YAMAMOTO, Osaka (JP)

(21) Appl. No.: 19/424,571

(22) Filed: Dec. 18, 2025

Related U.S. Application Data
(63) Continuation of application No. PCT/JP2024/022215, filed on Jun. 19, 2024.

(30) Foreign Application Priority Data
Jun. 20, 2023 (JP) 2023-100700
Jun. 20, 2023 (JP) 2023-100866
Jun. 19, 2024 (JP) 2024-098523
Jun. 19, 2024 (JP) 2024-098524

(51) Int. Cl. G05D 7/06; G01F 1/50; G01F 15/04

(52) U.S. Cl. CPC G05D 7/0623; G01F 1/50; G01F 15/043

(57) ABSTRACT

According to an aspect, a flow rate control system includes: a gas pipe; a flow rate adjuster; a pressure sensor disposed on a primary side of the flow rate adjuster and configured to detect an actual static pressure of gas flowing through the gas pipe; a temperature sensor disposed on the primary side of the flow rate adjuster and configured to detect an actual temperature of gas flowing through the gas pipe; and a control device. The control device stores a reference density, a reference velocity, a reference static pressure, and a reference temperature, calculates an actual flow rate of the gas flowing through the gas pipe using the actual static pressure, the actual temperature, the reference density, the reference velocity, the reference static pressure, and the reference temperature, and determines a manipulated variable of the flow rate adjuster to make the actual flow rate equal to a target rate.

### CROSS-REFERENCE TO RELATED APPLICATION

This application claims the benefit of priority from Japanese Patent Application No. 2023-100700 filed on Jun. 20, 2023, Japanese Patent Application No. 2023-100866 filed on Jun. 20, 2023, Japanese Patent Application No. 2024-098523 filed on Jun. 19, 2024, Japanese Patent Application No. 2024-098524 filed on Jun. 19, 2024, and International Patent Application No. PCT/JP2024/022215 filed on Jun. 19, 2024, the entire contents of which are incorporated herein by reference.

### BACKGROUND

### 1. Technical Field

What is disclosed herein relates to a flow rate control system and a flow rate control method.

### 2. Description of the Related Art

Japanese Patent No. 3638911 discloses a flow rate control device including a flow rate measuring unit that measures the flow rate of discharged fluid pumped from a fluid machine and a controller that controls the number of rotations of a driven shaft of the fluid machine based on the results of measurement by the flow rate measuring unit. The flow rate measuring unit is disposed in a flow-back path that returns the fluid in a discharge path to an intake path. As the flow rate measuring unit, for example, Venturi tubes, vortex flowmeters, hot wire flowmeters, and the like can be used.

If the flow rate measuring unit is disposed in the flow path through which the fluid flows, the fluid is in direct contact with the flow rate measuring unit. If the fluid is gas containing a relatively large amount of dust or the fluid is a corrosive gas, the flow rate measuring unit may possibly be worn or corroded. In this case, the flow rate of the fluid may fail to be accurately detected.

For the foregoing reasons, there is a need for a flow rate control system that accurately measures the flow rate of gas and adjusts the flow rate of the gas independently of inclusions of the gas.

### SUMMARY

According to an aspect of the present disclosure, a flow rate control system includes: a gas pipe through which gas flows; a flow rate adjuster disposed in the gas pipe and configured to adjust a flow rate of the gas; a pressure sensor disposed on a primary side of the flow rate adjuster in the gas pipe and configured to detect an actual static pressure serving as an actual static pressure of the gas flowing through the gas pipe; a temperature sensor disposed on the primary side of the flow rate adjuster in the gas pipe and configured to detect an actual temperature serving as an actual temperature of the gas flowing through the gas pipe; and a control device configured to control the flow rate adjuster. The control device stores therein in advance a reference density serving as a density for reference, a reference velocity serving as a velocity for reference, a reference static pressure serving as a static pressure for reference, and a reference temperature serving as a temperature for reference determined in advance for the gas. The control device calculates an actual flow rate serving as an actual flow rate of the gas flowing through the gas pipe using the actual static pressure, the actual temperature, the reference density, the reference velocity, the reference static pressure, and the reference temperature. The control device determines a manipulated variable of the flow rate adjuster so as to make the actual flow rate equal to a target flow rate.

According to an aspect of the present disclosure, a flow rate control method includes: detecting an actual static pressure serving as an actual static pressure of gas flowing through a gas pipe and an actual temperature serving as an actual temperature of the gas flowing through the gas pipe, the gas being adjusted by a flow rate adjuster; calculating an actual flow rate serving as an actual flow rate of the gas, using the actual static pressure and the actual temperature detected at the detecting the actual static pressure and the actual temperature, and a reference density serving as a density for reference, a reference velocity serving as a velocity for reference, a reference static pressure serving as a static pressure for reference, and a reference temperature serving as a temperature for reference determined in advance for the gas; and determining a manipulated variable of the flow rate adjuster so as to make the actual flow rate calculated at the calculating the actual flow rate equal to a target flow rate.

According to an aspect of the present disclosure, a flow rate control system includes: a gas pipe through which gas flows; a first flow rate adjuster and a second flow rate adjuster disposed in the gas pipe and configured to adjust a flow rate of the gas; a pressure sensor disposed on a primary side of the first flow rate adjuster and a primary side of the second flow rate adjuster in the gas pipe and configured to detect an actual static pressure serving as an actual static pressure of the gas flowing through the gas pipe; a temperature sensor disposed on the primary side of the first flow rate adjuster and the primary side of the second flow rate adjuster in the gas pipe and configured to detect an actual temperature serving as an actual temperature of the gas flowing through the gas pipe; and a control device configured to control the first flow rate adjuster and the second flow rate adjuster. The control device stores therein in advance a reference density serving as a density for reference, a reference velocity serving as a velocity for reference, a reference static pressure serving as a static pressure for reference, and a reference temperature serving as a temperature for reference determined in advance for the gas, and a normal flow rate range serving as a range of the flow rate of the gas in which the first flow rate adjuster operates properly. The control device calculates an actual flow rate serving as an actual flow rate of the gas flowing through the gas pipe, using the actual static pressure, the actual temperature, the reference density, the reference velocity, the reference static pressure, and the reference temperature. The control device determines a manipulated variable of the first flow rate adjuster so as to make the actual flow rate equal to a target flow rate when the actual flow rate is within the normal flow rate range. The control device determines a manipulated variable of the second flow rate adjuster such that the actual flow rate falls within the normal flow rate range when the actual flow rate is outside the normal flow rate range.

According to an aspect of the present disclosure, a flow rate control method includes: detecting an actual static pressure serving as an actual static pressure of gas flowing through a gas pipe and an actual temperature serving as an actual temperature of the gas in the gas flowing through the gas pipe and the flow rate of which is adjusted by a first flow rate adjuster and a second flow rate adjuster; calculating an actual flow rate serving as an actual flow rate of the gas using the actual static pressure and the actual temperature detected at the detecting the actual static pressure and the actual temperature, and a reference density serving as a density for reference, a reference velocity serving as a velocity for reference, a reference static pressure serving as a static pressure for reference, and a reference temperature serving as a temperature for reference determined in advance for the gas; determining whether the actual flow rate calculated at the calculating the actual flow rate is within a normal flow rate range serving as a range of the flow rate of the gas in which the first flow rate adjuster operates properly; determining a manipulated variable of the first flow rate adjuster so as to make the actual flow rate equal to a target flow rate when it is determined that the actual flow rate is within the normal flow rate range at the determining whether the actual flow rate is within the normal flow rate range; and determining a manipulated variable of the second flow rate adjuster such that the actual flow rate falls within the normal flow rate range when it is determined that the actual flow rate is outside the normal flow rate range at the determining whether the actual flow rate is within the normal flow rate range.

### BRIEF DESCRIPTION OF THE DRAWINGS

FIG. 1 is a schematic illustrating the configuration of a flow rate control system according to a first embodiment of the present disclosure;

FIG. 2 is a schematic illustrating a temperature sensor and a pressure sensor illustrated in FIG. 1;

FIG. 3 is a flowchart executed by a flow rate controller illustrated in FIG. 1 to calculate the actual flow rate and determine the manipulated valuable for a blower;

FIG. 4 is a diagram illustrating the relation between the flow rate of gas, the intake pressure of the blower, and the number of rotations of a blower motor in the flow rate control system illustrated in FIG. 1;

FIG. 5 is a schematic illustrating the configuration of the flow rate control system according to a first modification of the first embodiment of the present disclosure; FIG. 6 is a schematic illustrating the configuration of the flow rate control system according to a second modification of the first embodiment of the present disclosure; FIG. 7 is a schematic illustrating the configuration of the flow rate control system according to a third modification of the first embodiment of the present disclosure;

FIG. 8 is a schematic illustrating the configuration of the flow rate control system according to a second embodiment of the present disclosure;

FIG. 9 is a diagram illustrating the relation between the flow rate of the gas, the intake pressure of the blower, and the number of rotations of the blower motor in the flow rate control system illustrated in FIG. 8;

FIG. 10 is a flowchart executed by the flow rate controller illustrated in FIG. 8 to calculate the actual flow rate and determine the manipulated variable of the blower and the manipulated variable of a damper;

FIG. 11 is a schematic illustrating the configuration of the flow rate control system according to a first modification of the second embodiment of the present disclosure;

FIG. 12 is a schematic illustrating the configuration of the flow rate control system according to a second modification of the second embodiment of the present disclosure;

FIG. 13 is a schematic illustrating the temperature sensor of the flow rate control system according to another modification of the embodiments of the present disclosure; and

FIG. 14 is a diagram illustrating the configuration of the flow rate control system according to another modification of the embodiments of the present disclosure.

### DETAILED DESCRIPTION

Embodiments according to the present disclosure are described below with reference to the drawings. The present disclosure is not limited by what is described in the embodiments below. Moreover, components described below include components easily conceivable by those skilled in the art and components substantially identical therewith. Furthermore, the components described below can be combined as appropriate.

Moreover, to simplify the explanation, the drawings may illustrate the width, the thickness, the shape, and other elements of each unit more schematically than the actual aspect, however, these elements are given by way of example only and are not intended to limit interpretation of the present disclosure. Moreover, in the present specification and the figures, the same components as those previously described with reference to previous figures are denoted by the same reference numerals, and detailed explanation thereof may be appropriately omitted.

### First Embodiment

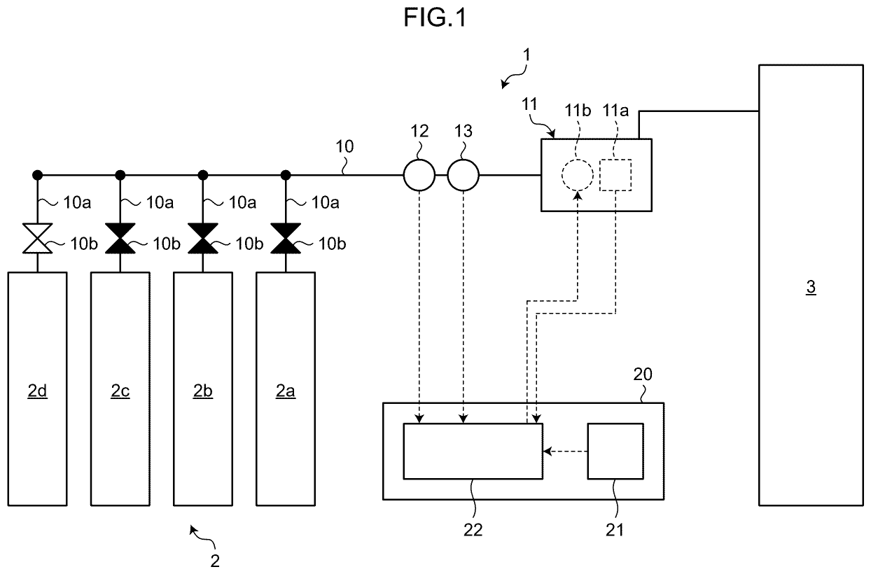

FIG. 1 is a schematic illustrating the configuration of a flow rate control system 1 according to a first embodiment of the present disclosure. The flow rate control system 1 connects a plurality of industrial furnaces 2 and a gas treatment apparatus 3 and supplies gas discharged from the industrial furnaces 2 to the gas treatment apparatus 3.

The number of industrial furnaces 2 according to the present embodiment is four, and a first industrial furnace 2a, a second industrial furnace 2b, a third industrial furnace 2c, and a fourth industrial furnace 2d are connected to the flow rate control system 1. The number of industrial furnaces 2 is not limited to four. Moreover, the first industrial furnace 2a, the second industrial furnace 2b, the third industrial furnace 2c, and the fourth industrial furnace 2d are simply referred to as “industrial furnaces 2” when the explanation is made without distinguishing them from one another.

The industrial furnace 2 is an industrial furnace used for manufacturing processes in the aluminum industry, for example. The industrial furnace 2 is not limited to that used in the aluminum industry. Examples of the industrial furnace 2 may include, but are not limited to, a firing furnace, a roasting furnace, a graphitizing furnace, a brazing furnace, a heat treatment furnace, a melting furnace used to melt raw materials, etc. The gas discharged from the industrial furnace 2 contains sulfur (specifically, sulfur oxides) and moisture.

The gas treatment apparatus 3 is a desulfurization apparatus that desulfurizes gas. The gas treatment apparatus 3 is not limited to a desulfurization apparatus. The gas treated by the gas treatment apparatus 3 is released to the atmosphere.

The flow rate control system 1 includes a gas pipe 10, a blower 11, a temperature sensor 12, a pressure sensor 13, and a control device 20. In the first embodiment, the blower 11 is a “flow rate adjuster”.

The gas pipe 10 connects the industrial furnaces 2 and the gas treatment apparatus 3, and the gas discharged from each of the industrial furnaces 2 flows through the gas pipe 10. The gas pipe 10 is what is called a duct.

Each industrial furnace 2 and the gas pipe 10 are connected via a coupling pipe 10a. The coupling pipe 10a is provided with an open/close valve 10b. When the open/close valve 10b is in an open state, the gas is discharged from the industrial furnace 2 corresponding to the open/close valve 10b in the open state. The degree of opening and closing of the open/close valve 10b is controlled by the control device 20 to such a state that the gas discharged from one of the industrial furnaces 2 flows into the gas pipe 10. In FIG. 1, the open/close valves 10b corresponding to the first industrial furnace 2a, the second industrial furnace 2b, and the third industrial furnace 2c are in a closed state. Moreover, the open/close valve 10b corresponding to the fourth industrial furnace 2d is in the open state.

In the following description, the path of the gas between the first industrial furnace 2a and the gas treatment apparatus 3 is referred to as a first system, the path of the gas between the second industrial furnace 2b and the gas treatment apparatus 3 is referred to as a second system, the path of the gas between the third industrial furnace 2c and the gas treatment apparatus 3 is referred to as a third system, and the path of the gas between the fourth industrial furnace 2d and the gas treatment apparatus 3 is referred to as a fourth system. Moreover, the first system, the second system, the third system, and the fourth system are simply referred to as “systems” when the explanation is made without distinguishing them from one another. FIG. 1 illustrates a state in which, among the open/close valves 10b, the open/close valve 10b corresponding to the fourth industrial furnace 2d is in the open state, and the gas flows through the fourth system.

For the industrial furnaces 2, the lengths of the path of the gas between the industrial furnaces 2 and the gas treatment apparatus 3 are different from one another. Specifically, the length of the path of the gas increases, and the pipeline resistance between the industrial furnace 2 and the gas treatment apparatus 3 increases in the order of the first system, the second system, the third system, and the fourth system.

The blower 11 is disposed in the gas pipe 10 and delivers the gas. The blower 11 includes a rotating part 11a and a blower motor 11b. The rotating part 11a includes an impeller (not illustrated). The blower motor 11b is an electric motor that rotates the rotating part 11a. The blower motor 11b rotates the rotating part 11a to deliver the gas. As the number of rotations (rotations per unit time: hereinafter the same shall apply) of the blower motor 11b increases, the flow rate (flow rate per unit time: hereinafter the same shall apply) of the gas flowing through the gas pipe 10 increases. The blower 11 may further include a rotation number sensor that detects the number of rotations per unit time of the rotating part 11a. Examples of the rotation number sensor include, but are not limited to, a mechanical rotary encoder, an optical rotary encoder, a magnetic rotary encoder, and an electromagnetic inductive rotary encoder. The number of rotations detected by the rotation number sensor is output to the control device 20. The number of rotations of the rotating part 11a is in proportion to the number of rotations of the blower motor 11b.

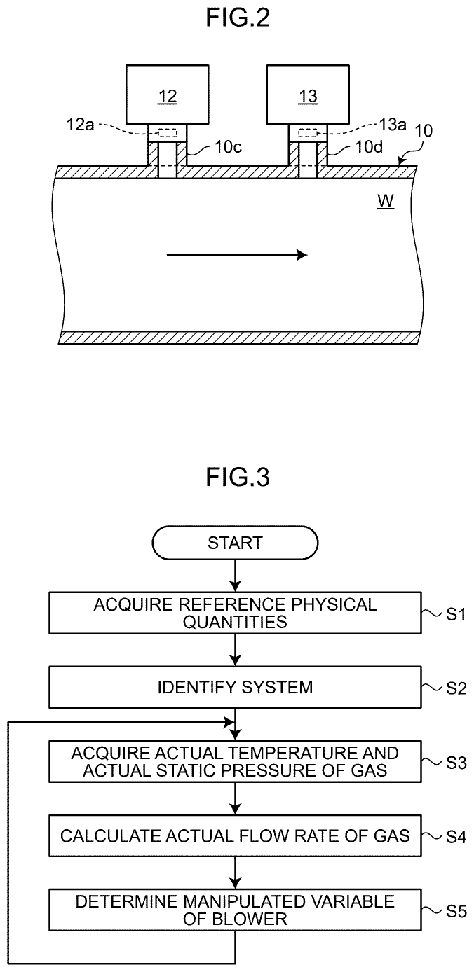

FIG. 2 is a schematic illustrating the temperature sensor 12 and the pressure sensor 13 illustrated in FIG. 1. The arrow illustrated in FIG. 2 indicates the direction in which the gas flows in a flow path W in the gas pipe 10. The flow path W is formed by the inner peripheral surface of the gas pipe 10.

The temperature sensor 12 is disposed on the gas pipe 10 on the primary side of the blower 11 and detects the temperature of the gas. The temperature sensor 12 is disposed on the gas pipe 10 with a first branch pipe 10c interposed therebetween. In other words, the temperature sensor 12 is disposed at a portion away from the flow path W through which the gas flows in the gas pipe 10. A temperature detector 12a with which the temperature sensor 12 detects the temperature is provided outside the flow path W. The temperature detected by the temperature sensor 12 is output to the control device 20.

The pressure sensor 13 is disposed on the gas pipe 10 on the primary side of the blower 11 and detects the static pressure of the gas. The pressure sensor 13 is disposed on the gas pipe 10 with a second branch pipe 10d interposed therebetween. In other words, the pressure sensor 13 is disposed at a portion away from the flow path W through which the gas flows in the gas pipe 10. A pressure detector 13a with which the pressure sensor 13 detects the static pressure is provided outside the flow path W. The static pressure detected by the pressure sensor 13 is output to the control device 20.

The temperature sensor 12 and the pressure sensor 13 are disposed on the gas pipe 10 with the branch pipes 10c and 10d interposed therebetween and are not disposed in the flow path W of the gas in the gas pipe 10. This configuration suppresses the influence of the components contained in the gas, such as sulfur, and the inclusions, such as soot and dust, on the temperature sensor 12 and the pressure sensor 13. Therefore, damage to the temperature sensor 12 and the pressure sensor 13 caused by corrosion and wear, for example, due to the components and inclusions of the gas can be suppressed.

The control device 20 illustrated in FIG. 1 provides centralized control of the flow rate control system 1. The control device 20 controls the blower 11 to supply the gas discharged from the industrial furnace 2 to the gas treatment apparatus 3. The control device 20 includes a storage 21 and a flow rate controller 22.

The storage 21 stores therein in advance data of reference physical quantities obtained by an operator's measuring (detecting) the components and conditions of the gas in advance and input by the operator. Specifically, the reference physical quantities are a reference density serving as the density for reference, a reference velocity serving as the velocity for reference, a reference static pressure serving as the static pressure for reference, and a reference temperature serving as the temperature for reference.

The reference density, the reference velocity, the reference static pressure, and the reference temperature are determined by the operator's operating the industrial furnace 2 at a timing other than the time for producing a product and measuring the velocity, the static pressure, and the temperature of the gas flowing through the gas pipe 10. When measuring the reference density, the reference velocity, the reference static pressure, and the reference temperature, the operator does not necessarily operate the industrial furnace 2. The reference density is calculated based on the results of an analysis carried out by the operator on the composition of the gas flowing through the gas pipe 10, for example. The reference velocity is measured by a measuring instrument, such as a pitot tube, disposed in the gas pipe 10 (flow path W). The measuring instrument that measures the reference velocity is disposed in the gas pipe 10 at a portion of the flow path W having the sectional area equal to that of the flow path W corresponding to the portion provided with the pressure sensor 13.

Moreover, the reference static pressure is measured (detected) by the pressure sensor 13. The reference temperature is measured (detected) by the temperature sensor 12.

Moreover, as described above, the pipeline resistance between the industrial furnace 2 and the gas treatment apparatus 3 increases in the order of the first system, the second system, the third system, and the fourth system. In other words, the relations between the reference density, the reference velocity, the reference static pressure, and the reference temperature differ between the systems. In other words, the reference density, the reference velocity, the reference static pressure, and the reference temperature are input by the operator individually for each of the systems and stored in the storage 21.

The flow rate controller 22 controls, by using the blower 11, an actual flow rate of the gas flowing through the gas pipe 10 (hereinafter referred to as an actual flow rate) when the industrial furnace 2 is operating during product manufacturing. Specifically, the flow rate controller 22 calculates the actual flow rate of the gas flowing through the gas pipe 10 based on the detection values of the temperature sensor 12 and the pressure sensor 13 and performs feedback control to determine the manipulated variable of the blower 11 such that the calculated actual flow rate is equal to a target flow rate (which will be described later in detail). In the first embodiment, the feedback control is PID controller (Proportional-Integral-Differential Controller), for example.

FIG. 3 is a flowchart executed by the flow rate controller 22 illustrated in FIG. 1 to calculate the actual flow rate and determine the manipulated variable of the blower 11. The flow rate controller 22 executes the flowchart illustrated in FIG. 3 during product manufacturing. Product manufacturing is carried out in one of the industrial furnaces 2. In other words, during product manufacturing, only the open/close valve 10b corresponding to one industrial furnace 2 used for product manufacturing is in the open state, and the gas discharged from the one industrial furnace 2 flows through the system corresponding to the one industrial furnace 2. The following describes a case where the open/close valve 10b corresponding to the fourth industrial furnace 2d is in the open state and the gas flows through the fourth system as illustrated in FIG. 1.

At the start of product manufacturing, the flow rate controller 22 controls the blower motor 11b of the blower 11 at a predetermined number of rotations. As a result, the gas discharged from the industrial furnace 2 is supplied to the gas treatment apparatus 3 via the gas pipe 10. The predetermined number of rotations is, for example, the number of rotations at which the flow rate of the gas flowing through the gas pipe 10 is smaller than the target flow rate, which will be described later.

The flow rate controller 22 acquires the reference physical quantities at Step S1. Specifically, the flow rate controller 22 acquires the reference density, the reference velocity, the reference static pressure, and the reference temperature determined in advance for the gas from the storage 21.

Subsequently, at Step S2, the flow rate controller 22 identifies the system through which the gas flows. Specifically, the flow rate controller 22 identifies the system in which the corresponding open/close valve 10b is in the open state. As illustrated in FIG. 1, if the open/close valve 10b corresponding to the fourth industrial furnace 2d is in the open state, the flow rate controller 22 identifies the fourth system.

Furthermore, the flow rate controller 22 acquires an actual temperature and an actual static pressure of the gas at Step S3. The actual temperature is an actual temperature of the gas flowing through the gas pipe 10 (system) during product manufacturing and is a temperature detected by the temperature sensor 12. The actual static pressure is an actual static pressure of the gas flowing through the gas pipe 10 (system) during product manufacturing and is a static pressure detected by the pressure sensor 13.

Subsequently, the flow rate controller 22 calculates the actual flow rate of the gas at Step S4. The flow rate controller 22 calculates the actual flow rate using Expressions (1), (2), (3), (4), (5), and (6) below. Expressions (1), (2), (3), (4), (5), and (6) are stored in the storage 21.

$${PT}_{0} = {PS}_{0} + {PD}_{0} \qquad ( 1 )$$

$${PD}_{0} = ( {ρ}_{0} \times {V}_{0}^{2} / 2 ) \times {10}^{- 3} \qquad ( 2 )$$

$${PS}_{1}^{′} = {PS}_{1} \times ( 273.15 + {T}_{1} ) / ( 273.15 + {T}_{0} ) \qquad ( 3 )$$

$${PT}_{1}^{′} = {PS}_{1}^{′} + ( {ρ}_{0} \times {V}_{1}^{2} / 2 ) \times {10}^{- 3} \qquad ( 4 )$$

$${PT}_{1}^{′} = {PT}_{0} \times {( {V}_{1} / {V}_{0} )}^{2} \qquad ( 5 )$$

$$Gw = A \times {V}_{1} \qquad ( 6 )$$

In Expression (1), PT₀ is the reference total pressure (unit: kPa) serving as the total pressure for reference of the gas, PS₀ is the reference static pressure (unit: kPa), and PD₀ is the reference velocity pressure (unit: kPa) serving as the velocity pressure for reference of the gas. Expression (1) indicates that the sum of the reference static pressure (PS₀) and the reference velocity pressure (PD₀) is the reference total pressure (PT₀).

In Expression (2), ρ₀ is the reference density (unit: kg/m³), and V₀ is the reference velocity (unit: m/s). Expression (2) is an expression indicating the kinetic energy of the gas using the unit of pressure and is derived based on Bernoulli's principle. As described above, the reference static pressure (PS₀), the reference density (ρ₀), and the reference velocity (V₀) are acquired at Step S1.

The flow rate controller 22 calculates the reference velocity pressure (PD₀) and the reference total pressure (PT₀) using Expressions (1) and (2) and the reference static pressure (PS₀), the reference density (ρ₀), and the reference velocity (V₀) corresponding to the system identified at Step S2.

In Expression (3), PS₁ is the actual static pressure (unit: kPa) acquired at Step S3, T₁ is the actual temperature (unit: ° C.) acquired at Step S3, and TO is the reference temperature (unit: ° C.) corresponding to the system identified at Step S2. In other words, PS₁′ in Expression (3) is a value obtained by adjusting PS₁ to the conditions of the reference temperature of the gas.

In Expression (4), PT₁′ is a value obtained by adjusting the actual total pressure (unit: kPa) serving as the actual total pressure of the gas to the conditions of the reference temperature. Similarly to Expression (2), the second term in Expression (4) is an expression indicating the kinetic energy of the gas in the unit of pressure and is derived based on Bernoulli's principle.

Expression (5) is an expression indicating the relation between the reference total pressure (PT₀) and the adjusted actual total pressure (PT₁′). Expression (5) is derived based on the fact that the pressure loss of the gas is proportional to the velocity squared of the gas.

The flow rate controller 22 calculates the actual velocity (V₁) using Expressions (3), (4), and (5), the actual static pressure (PS₁) and the actual temperature (T₁) acquired at Step S3, the reference velocity pressure (PD₀) and the reference total pressure (PT₀) calculated using Expressions (1) and (2), and the reference temperature (T₀) and the reference density (ρ₀).

In Expression (6), Gw is the actual flow rate (unit: m³/s), and A is the cross-sectional area (unit: m²) of the flow path W corresponding to the portion provided with the pressure sensor 13. The cross-sectional area (A) of the flow path W is stored in advance in the storage 21. Each system has an equal cross-sectional area (A) of the flow path W.

The flow rate controller 22 calculates the actual flow rate (Gw) using Expression (6) and the actual velocity (V₁) calculated as described above.

Furthermore, the flow rate controller 22 determines the manipulated variable of the blower 11 at Step S5. Specifically, the flow rate controller 22 determines the number of rotations (number of rotations per unit time) of the blower motor 11b of the blower 11 so as to make the actual flow rate calculated at Step S4 equal to the target flow rate, based on the deviation between the actual flow rate and the target flow rate. The manipulated variable in the present embodiment is the number of rotations of the blower motor 11b.

The target flow rate is determined by the production volume and the desulfurization efficiency of the gas treatment apparatus 3 and is input to the control device 20 by the operator in advance. Moreover, the target flow rate is determined within a range corresponding to the region described below.

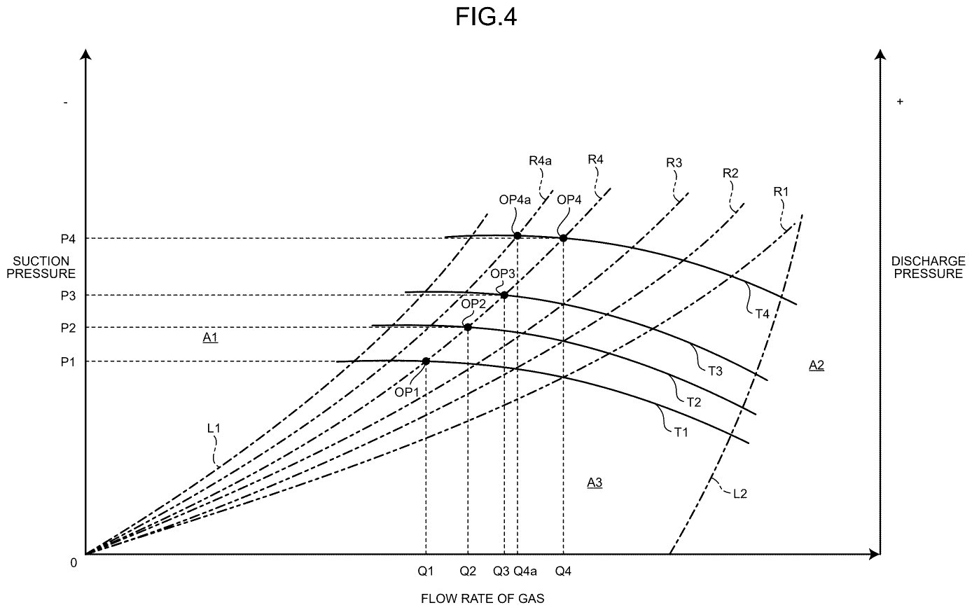

FIG. 4 is a diagram illustrating the relation between the flow rate of the gas, the intake pressure of the blower 11, and the number of rotations of the blower motor 11b in the flow rate control system 1 illustrated in FIG. 1. In FIG. 4, the horizontal axis indicates the flow rate of the gas, the left vertical axis indicates the intake pressure of the blower 11 (i.e., pressure (total pressure) on the primary side of the blower 11 in the gas pipe 10), and the right vertical axis indicates the discharge pressure of the blower 11 (i.e., pressure (total pressure) on the secondary side of the blower 11 in the gas pipe 10). The direction in which the arrow points on the left vertical axis is a direction in which the negative value decreases (the absolute value of the negative value increases), and the direction in which the arrow points on the right vertical axis is a direction in which the positive value increases (the absolute value thereof increases).

The five curves represented by the long and two short dashes lines in FIG. 4 are resistance curves of the respective systems: a first resistance curve R1, a second resistance curve R2, a third resistance curve R3, a fourth resistance curve R4, and a secondary fourth resistance curve R4a. The first resistance curve R1 corresponds to the first system. The second resistance curve R2 corresponds to the second system. The third resistance curve R3 corresponds to the third system. The fourth resistance curve R4 corresponds to the fourth system. As described above, the pipeline resistance increases in the order of the first system, the second system, the third system, and the fourth system, and the gradient of the curve increases in the order of the first resistance curve R1, the second resistance curve R2, the third resistance curve R3, and the fourth resistance curve R4. The secondary fourth resistance curve R4a will be described later.

The four curves represented by the solid lines in FIG. 4 are each a characteristic curve of the blower 11 corresponding to a certain number of rotations of the blower motor 11b. The number of rotations of the blower motor 11b increases in the order of a first characteristic curve T1, a second characteristic curve T2, a third characteristic curve T3, and a fourth characteristic curve T₄. Moreover, the flow rate of the gas corresponding to the intersection of the characteristic curve and the resistance curve corresponds to the flow rate of the gas at the number of rotations of the characteristic curve.

For example, when the gas flows through the fourth system and the number of rotations of the blower motor 11b is that of the first characteristic curve T1, the flow rate of the gas is a first flow rate Q1 corresponding to a first operating point OP1, which is the intersection of the fourth resistance curve R4 and the first characteristic curve T1. Similarly, when the number of rotations of the blower motor 11b is that of the second characteristic curve T2, the flow rate of the gas is a second flow rate Q2 corresponding to a second operating point OP2, which is the intersection of the fourth resistance curve R4 and the second characteristic curve T2.

Moreover, similarly, when the number of rotations of the blower motor 11b is that of the third characteristic curve T3, the flow rate of the gas is a third flow rate Q3 corresponding to a third operating point OP3, which is the intersection of the fourth resistance curve R4 and the third characteristic curve T3. Similarly, when the number of rotations of the blower motor 11b is that of the fourth characteristic curve T4, the flow rate of the gas is a fourth flow rate Q4 corresponding to a fourth operating point OP4, which is the intersection of the fourth resistance curve R4 and the fourth characteristic curve T4. In the following description, the first operating point OP1, the second operating point OP2, the third operating point OP3, and the fourth operating point OP4 are simply referred to as “operating points” when they are not distinguished from one another.

Moreover, when the gas flows through the fourth system and the number of rotations of the blower motor 11b is that of the first characteristic curve T1, the intake pressure is a first pressure P1 corresponding to the first operating point OP1. Similarly, when the number of rotations of the blower motor 11b is that of the second characteristic curve T2, the intake pressure is a second pressure P2 corresponding to the second operating point OP2.

Moreover, similarly, when the number of rotations of the blower motor 11b is that of the third characteristic curve T3, the intake pressure is a third pressure P3 corresponding to the third operating point OP3. Similarly, when the number of rotations of the blower motor 11b is that of the fourth characteristic curve T4, the intake pressure is a fourth pressure P4 corresponding to the fourth operating point OP4.

The resistance curve indicates that the intake pressure decreases as the flow rate of the gas increases. Moreover, the intersection (operating point) of the resistance curve and the characteristic curve corresponding to the certain number of rotations is uniquely determined. Therefore, the first flow rate Q1, the second flow rate Q2, the third flow rate Q3, and the fourth flow rate Q4 are different from one another and increase in this order. Moreover, the first pressure P1, the second pressure P2, the third pressure P3, and the fourth pressure P4 are different from one another and decrease in this order.

Thus, when the gas flows through the fourth system, the flow rate of the gas and the intake pressure vary along the fourth resistance curve R4 according to the number of rotations of the blower motor 11b. The same applies to the other systems.

For example, when the gas flows through the fourth system and the number of rotations of the blower motor 11b is that of the fourth characteristic curve T4, the fourth pressure P4 corresponding to the fourth operating point OP4 corresponds to the actual static pressure (PS₁) acquired at Step S3 described above, and the fourth flow rate Q4 corresponding to the fourth operating point OP4 corresponds to the actual flow rate (Gw) calculated at Step S4 described above. The same applies to the intake pressure and the flow rate of the gas corresponding to the other operating points in the fourth resistance curve R4 and the intake pressure and the flow rate of the gas corresponding to the operating point in the other resistance curves.

The target flow rate is determined such that the operating point is positioned in the region between a first boundary line L1 and a second boundary line L2 illustrated in FIG. 4. In FIG. 4, a region A1 where the flow rate of the gas is smaller than the first boundary line L1 is a region where the flow rate of the gas is small with respect to the intake pressure (discharge pressure), thereby causing the phenomenon that the operating state of the blower 11 is unstable (what is called a surging phenomenon). By contrast, in FIG. 4, a region A2 where the flow rate is larger than the second boundary line L2 is a region where the phenomenon occurs that the flow rate of the gas does not increase when the pressure on the primary side of the blower 11 increases (what is called a choke phenomenon).

The target flow rate is determined within such a range that the operating point is positioned in a region A3 between the first boundary line L1 and the second boundary line L2. In other words, the target flow rate is determined within the range of the flow rate corresponding to the region A3 where the operation of the blower 11 is stable and the flow rate increases as the number of rotations of the rotating part 11a increases. Similarly to the target flow rate, the predetermined flow rate described above is also determined within the range of the flow rate corresponding to the region A3.

At Step S5 illustrated in FIG. 3, the flow rate controller 22 determines the number of rotations of the blower motor 11b so as to reduce the deviation between the actual flow rate calculated at Step S4 and the target flow rate. The flow rate controller 22 outputs the determined number of rotations to the blower 11. The blower motor 11b rotates at the output number of rotations, whereby the flow rate of the gas flowing through the gas pipe 10 (system) approaches the target flow rate.

When Step S5 is completed, the flow rate controller 22 returns the computer program process to Step S3. Thus, the flow rate controller 22 repeatedly performs Steps S3, S4, and S5 during product manufacturing, thereby adjusting the flow rate through the gas pipe 10 so as to make it equal to the target flow rate. As described above, the flow rate control system 1 can accurately regulate the flow rate of the gas flowing through the gas pipe 10 without disposing a measuring instrument or the like in the flow path W of the gas in the gas pipe 10.

As described above, the flow rate control system 1 according to the present embodiment includes the gas pipe 10 through which the gas flows, the blower 11 disposed in the gas pipe 10 and that adjusts the flow rate of the gas, the pressure sensor 13 disposed on the primary side of the blower 11 in the gas pipe 10 and that detects the actual static pressure serving as the actual static pressure of the gas flowing through the gas pipe 10, the temperature sensor 12 disposed on the primary side of the blower 11 in the gas pipe 10 and that detects the actual temperature serving as the actual temperature of the gas flowing through the gas pipe 10, and the control device 20 that controls the blower 11. The control device 20 stores therein in advance the reference density serving as the density for reference, the reference velocity serving as the velocity for reference, the reference static pressure serving as the static pressure for reference, and the reference temperature serving as the temperature for reference determined in advance for the gas, calculates the actual flow rate serving as the actual flow rate of the gas flowing through the gas pipe 10 using the actual static pressure, the actual temperature, the reference density, the reference velocity, the reference static pressure, and the reference temperature, and determines the manipulated variable of the blower 11 so as to make the actual flow rate equal to the target flow rate.

With this configuration, the flow rate control system 1 can accurately calculate the flow rate of the gas flowing through the gas pipe 10 by storing therein in advance the reference density and other data without disposing a measuring instrument or the like in the flow path W of the gas pipe 10. Moreover, the flow rate control system 1 can calculate the flow rate of the gas flowing through the gas pipe 10 while suppressing the effects of the characteristics (e.g., corrosiveness) of the gas and the inclusions, such as the object to be treated and fly ash. Therefore, the flow rate control system 1 can accurately measure the flow rate of the gas and regulate the flow rate of the gas independently of the properties of the gas.

Furthermore, the flow rate control system 1 does not require a measuring instrument (e.g., impeller flowmeter) in the flow path W to detect the flow rate of the gas as described above. Moreover, the flow rate control system 1 can regulate the flow rate of the gas without using a measuring instrument (e.g., ultrasonic flowmeter) disposed outside the flow path W and capable of detecting the flow rate of the gas. Therefore, the cost of the flow rate control system 1 can be reduced.

Moreover, the control device 20 calculates the actual flow rate using Expressions (1), (2), (3), (4), (5), and (6) above.

Therefore, the flow rate control system 1 can calculate the flow rate of the gas more accurately.

Moreover, the pressure sensor 13 and the temperature sensor 12 are disposed at respective portions away from the flow path W through which the gas flows in the gas pipe 10.

With this configuration, the pressure sensor 13 and the temperature sensor 12 are prevented from being affected by the properties of the gas. Therefore, the pressure sensor 13 can accurately detect the actual static pressure of the gas. Moreover, the temperature sensor 12 can accurately detect the actual temperature of the gas.

Moreover, the gas contains sulfur. The gas pipe 10 connects the industrial furnace 2 that discharges the gas and the gas treatment apparatus 3 (desulfurization apparatus) that desulfurizes the gas.

With this configuration, the flow rate control system 1 can accurately regulate the flow rate of the gas if the gas contains sulfur and the gas pipe 10 connects the industrial furnace 2 that discharges the gas and the desulfurization apparatus that desulfurizes the gas.

Next, the following mainly describes the parts in the flow rate control system 1 according to a first modification of the first embodiment of the present disclosure different from those in the first embodiment described above.

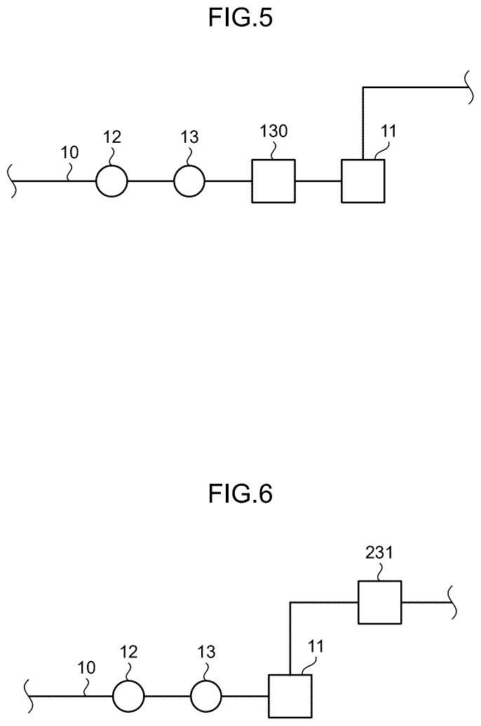

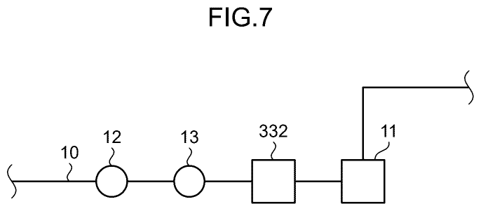

FIG. 5 is a schematic illustrating the configuration of the flow rate control system 1 according to the first modification of the first embodiment of the present disclosure. Compared with the flow rate control system 1 according to the embodiment described above, the flow rate control system 1 according to the first modification further includes a first damper 130. The first damper 130 is disposed on the primary side of the blower 11 in the gas pipe 10. The first damper 130 adjusts the flow rate of the gas flowing through the gas pipe 10. The first damper 130 is what is called an intake damper. In the first modification, the first damper 130 corresponds to the “flow rate adjuster”.

In the first modification, the flow rate controller 22 determines the manipulated variable of the first damper 130 at Step S5 illustrated in FIG. 3. Specifically, the flow rate controller 22 determines the manipulated variable of an actuator that adjusts the degree of opening of the first damper 130 so as to make the actual flow rate calculated at Step S4 equal to the target flow rate.

The flow rate controller 22 outputs the determined manipulated variable to the first damper 130. As a result, the degree of opening of the first damper 130 changes, and the flow rate of the gas flowing through the gas pipe 10 approaches the target flow rate.

For example, when the gas flows through the fourth system and the number of rotations of the blower motor 11b is that of the fourth characteristic curve T4, the pipeline resistance of the fourth system changes as the degree of opening of the first damper 130 changes. Specifically, when the degree of opening of the first damper 130 decreases by the manipulated variable determined by the flow rate controller 22, the pipeline resistance of the fourth system increases, and the fourth resistance curve R4 illustrated in FIG. 4 changes to the secondary fourth resistance curve R4a having a gradient larger than that of the fourth resistance curve R4. The operating point shifts from the fourth operating point OP4 to a secondary fourth operating point OP4a along the fourth characteristic curve T4 according to the change in gradient. Therefore, the flow rate of the gas is adjusted from the fourth flow rate Q4 corresponding to the fourth operating point OP4 to a secondary fourth flow rate Q4a.

In the first modification, the flow rate controller 22 may control the blower motor 11b of the blower 11 at the predetermined number of rotations described above or may adjust the number of rotations of the blower motor 11b according to the degree of opening of the first damper 130.

Next, the following mainly describes the parts in the flow rate control system 1 according to a second modification of the first embodiment of the present disclosure different from those in the first embodiment described above.

FIG. 6 is a schematic illustrating the configuration of the flow rate control system 1 according to the second modification of the first embodiment of the present disclosure. Compared with the flow rate control system 1 according to the embodiment described above, the flow rate control system 1 according to the second modification further includes a second damper 231. The second damper 231 is disposed on the secondary side of the blower 11 in the gas pipe 10. The second damper 231 adjusts the flow rate of the gas flowing through the gas pipe 10. The second damper 231 is what is called a discharge damper. In the second modification, the second damper 231 corresponds to the “flow rate adjuster”.

In the second modification, the flow rate controller 22 determines the manipulated variable of the second damper 231 at Step S5 illustrated in FIG. 3. Specifically, the flow rate controller 22 determines the manipulated variable of an actuator that adjusts the degree of opening of the second damper 231 so as to make the actual flow rate calculated at Step S4 equal to the target flow rate.

The flow rate controller 22 outputs the determined manipulated variable to the second damper 231. As a result, the degree of opening of the second damper 231 changes, and the flow rate of the gas flowing through the gas pipe 10 approaches the target flow rate. When the degree of opening of the second damper 231 changes, the pipeline resistance of the system changes, and the flow rate of the gas is adjusted in the same manner as when the degree of opening of the first damper 130 described above changes. In the second modification, the first damper 130 described above may be disposed.

Next, the flow rate control system 1 according to a third modification of the first embodiment of the present disclosure is described. The following mainly describes the parts different from the first embodiment described above.

FIG. 7 is a schematic illustrating the configuration of the flow rate control system 1 according to the third modification of the first embodiment of the present disclosure. Compared with the flow rate control system 1 according to the embodiment described above, the flow rate control system 1 according to the third modification further includes an inlet guide vane 332. The inlet guide vane 332 is disposed on the primary side of the blower 11 in the gas pipe 10. The inlet guide vane 332 adjusts the flow rate of the gas flowing through the gas pipe 10. In the third modification, the inlet guide vane 332 corresponds to the “flow rate adjuster”.

In the third modification, the flow rate controller 22 determines the manipulated variable of the inlet guide vane 332 at Step S5 illustrated in FIG. 3. Specifically, the flow rate controller 22 determines the manipulated variable of an actuator that adjusts the degree of opening of the inlet guide vane 332 so as to make the actual flow rate calculated at Step S4 equal to the target flow rate.

The flow rate controller 22 outputs the determined manipulated variable to the inlet guide vane 332. As a result, the degree of opening of the inlet guide vane 332 changes, and the flow rate of the gas flowing through the gas pipe 10 approaches the target flow rate. When the degree of opening of the inlet guide vane 332 changes, the pipeline resistance of the system changes, and the flow rate of the gas is adjusted in the same manner as when the degree of opening of the first damper 130 described above changes. In the third modification, at least one of the first damper 130 and the second damper 231 described above may be disposed.

### Second Embodiment

Next, the following mainly describes the differences in the flow rate control system 1 according to a second embodiment of the present disclosure from the flow rate control system 1 according to the first embodiment described above.

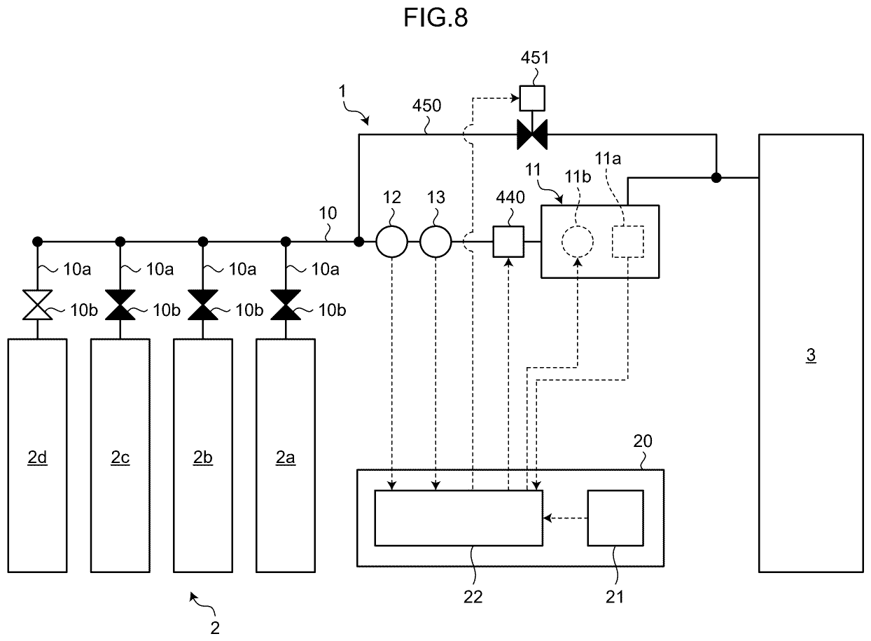

FIG. 8 is a schematic illustrating the configuration of the flow rate control system 1 according to the second embodiment of the present disclosure.

Compared with the flow rate control system 1 according to the first embodiment described above, the flow rate control system 1 according to the second embodiment further includes an intake damper 440, a bypass pipe 450, and a bypass pipe open/close valve 451. In the second embodiment, the blower 11 is a “first flow rate adjuster”, and the intake damper 440 corresponds to a “second flow rate adjuster”.

The intake damper 440 is disposed on the primary side of the blower 11 in the gas pipe 10. The intake damper 440 adjusts the flow rate of the gas flowing through the gas pipe 10. The degree of opening of the intake damper 440 is adjusted by an actuator (e.g., motor) included in the intake damper 440. The flow rate of the gas flowing through the gas pipe 10 increases as the degree of opening of the intake damper 440 increases by the driving of the actuator of the intake damper 440.

The bypass pipe 450 is a pipe that couples the primary side of the blower 11 and the primary side of the intake damper 440 to the secondary side of the blower 11 and the secondary side of the intake damper 440 in the gas pipe 10 and through which the gas flows. Specifically, the bypass pipe 450 couples the primary side of the temperature sensor 12 and the primary side of the pressure sensor 13 to the secondary side of the blower 11 and the secondary side of the intake damper 440 in the gas pipe 10.

The inner diameter of the bypass pipe 450 is smaller than that of the gas pipe 10, and the cross-sectional area of the flow path through which the gas flows in the bypass pipe 450 is smaller than that of the flow path W in the gas pipe 10.

The bypass pipe open/close valve 451 is disposed in the bypass pipe 450 and opens and closes the bypass pipe 450. In other words, the bypass pipe open/close valve 451 stops the flow of the gas in the bypass pipe 450 when it is in the closed state and allows the gas to flow in the bypass pipe 450 when it is in the open state. The bypass pipe open/close valve 451 is an electrically operated valve, for example. In FIG. 8, the bypass pipe open/close valve 451 is in the closed state. In other words, no gas flows in the bypass pipe 450 in FIG. 8.

The control device 20 illustrated in FIG. 8 controls the blower 11 and the intake damper 440 to supply the gas discharged from the industrial furnace 2 to the gas treatment apparatus 3. Moreover, the control device 20 also controls the degree of opening and closing of the bypass pipe open/close valve 451.

In the second embodiment, the storage 21 stores therein in advance six flow rate ranges described below besides the reference physical quantities described above.

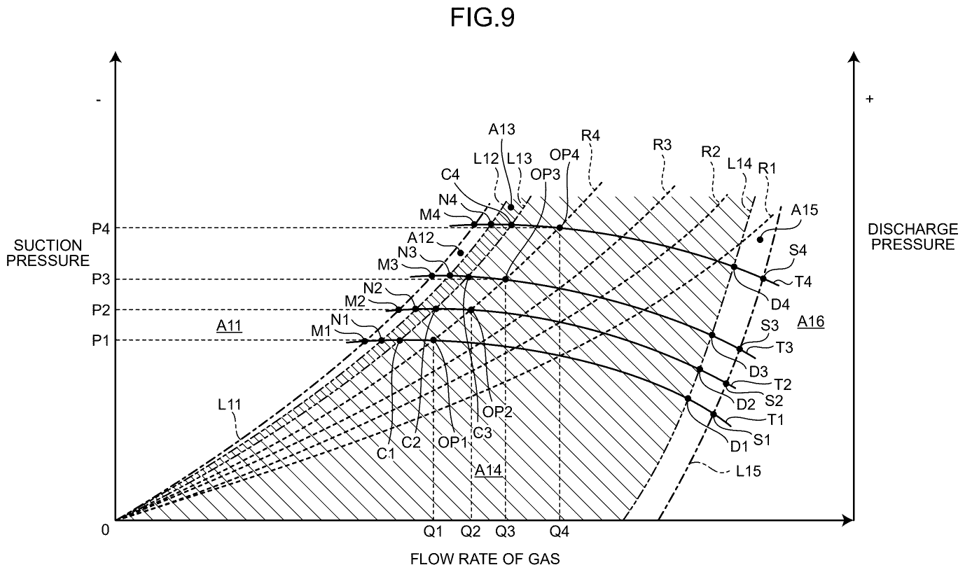

FIG. 9 is a diagram illustrating the relation between the flow rate of the gas, the intake pressure of the blower 11, and the number of rotations of the blower motor 11b. In FIG. 9, the horizontal axis indicates the flow rate of the gas flowing through the gas pipe 10, the left vertical axis indicates the intake pressure of the blower 11 (i.e., pressure (total pressure) on the primary side of the blower 11 in the gas pipe 10), and the right vertical axis indicates the discharge pressure of the blower 11 (i.e., pressure (total pressure) on the secondary side of the blower 11 in the gas pipe 10). The direction in which the arrow points on the left vertical axis is a direction in which the negative value decreases (the absolute value of the negative value increases), and the direction in which the arrow points on the right vertical axis is a direction in which the positive value increases (the absolute value thereof increases).

FIG. 9 illustrates a first boundary line L11, a second boundary line L12, a third boundary line L13, a fourth boundary line L14, and a fifth boundary line L15 that define six regions described below. The boundary lines L11 and L15 are determined by the performance characteristics of the blower 11 or other factors.

In the second boundary line L12, the flow rate of the gas with respect to a certain intake pressure is larger than that of the first boundary line L11 by a first predetermined ratio (e.g., 5%).

In the third boundary line L13, the flow rate of the gas with respect to the certain intake pressure is larger than that of the first boundary line L11 by a second predetermined ratio (e.g., 10%). The second predetermined ratio is larger than the first predetermined ratio. The second predetermined ratio is determined such that the surging phenomenon, which will be described later, is reliably suppressed in the region where the flow rate of the gas is larger than the third boundary line L13.

In the fourth boundary line L14, the flow rate of the gas with respect to the certain intake pressure is smaller than that of the fifth boundary line L15 by a third predetermined ratio (e.g., 10%). The third predetermined ratio is determined such that the choking phenomenon, which will be described later, is reliably suppressed in the region where the flow rate of the gas is smaller than the fourth boundary line L14. The third predetermined ratio may be equal to or different from the second predetermined ratio.

A region A11 is the region where the flow rate of the gas is smaller than the first boundary line L11. A region A12 is the region between the first boundary line L11 and the second boundary line L12. A region A13 is the region between the second boundary line L12 and the third boundary line L13.

A region A14 is the region between the third boundary line L13 and the fourth boundary line L14. A region A15 is the region between the fourth boundary line L14 and the fifth boundary line L15. A region A16 is the region where the flow rate of the gas is larger than the fifth boundary line L15. The first boundary line L11 is included in the region A11, the second boundary line L12 is included in the region A12, the third boundary line L13 is included in the region A13, the fourth boundary line L14 is included in the region A15, and the fifth boundary line L15 is included in the region A16.

Moreover, in the following description, the ranges of the flow rate of the gas corresponding to the region A11, the region A12, the region A13, the region A14, the region A15, and the region A16 are referred to as a first flow rate range, a second flow rate range (corresponding to a “predetermined flow rate range)), a third flow rate range, a fourth flow rate range (corresponding to a “normal flow rate range)), a fifth flow rate range, and a sixth flow rate range, respectively.

In the region A11 (first flow rate range), the flow rate of the gas is small with respect to the intake pressure (or discharge pressure), so that the blower 11 does not operate properly, thereby causing the phenomenon that the operating state of the blower 11 is unstable (what is called a surging phenomenon).

The region A12 (second flow rate range) is positioned between the region A11 and the region A13. In other words, the region A12 (second flow rate range) is closer to the region A11 where the surging phenomenon occurs than the region A13. The region A13 (third flow rate range) is positioned between the region A12 and the region A14. In other words, the region A13 (third flow rate range) is closer to the region A11 where the surging phenomenon occurs than the region A14.

The region A14 (fourth flow rate range) is positioned between the region A13 and the region A15. In other words, the region A14 (fourth flow rate range) is positioned between the boundary lines L3 and L4. By determining the boundary lines L3 and L4 as described above, the surging phenomenon and the choking phenomenon are reliably suppressed in the region A14 (fourth flow rate range).

In other words, the region A14 (fourth flow rate range) is the range of the flow rate of the gas in which the blower 11 operates properly. Specifically, the fourth flow rate range is the range in which the flow rate of the gas varies with the number of rotations of the blower 11 and the flow rate increases as the number of rotations of the rotating part 11a increases.

The region A15 (fifth flow rate range) is positioned between the region A14 and the region A16. In other words, the region A15 (fifth flow rate range) is closer to the region A16 where the choking phenomenon occurs than the region A14.

In the region A16 (sixth flow rate range), the blower 11 does not operate properly, thereby causing the phenomenon that the flow rate of the gas does not increase even if the pressure on the primary side of the blower 11 increases (what is called a choking phenomenon).

Thus, the flow rate of the gas increases in the order of the first flow rate range, the second flow rate range, the third flow rate range, the fourth flow rate range, the fifth flow rate range, and the sixth flow rate range. Moreover, the six flow rate ranges are determined corresponding to the number of rotations of the blower motor 11b.

Similarly to the curves represented by the solid lines in FIG. 4, the four curves represented by the solid lines in FIG. 9 are each a characteristic curve of the blower 11 corresponding to a certain number of rotations of the blower motor 11b. The number of rotations of the blower motor 11b increases in the order of the first characteristic curve T1, the second characteristic curve T2, the third characteristic curve T3, and the fourth characteristic curve T4.

In the first characteristic curve T1, for example, the range of the flow rate of the gas corresponding to the region A11 smaller than a point M1 corresponds to the first flow rate range corresponding to a first number of rotations. In the second characteristic curve T2, the range of the flow rate of the gas corresponding to the region A11 smaller than a point M2 corresponds to the first flow rate range corresponding to a second number of rotations.

In the third characteristic curve T3, the range of the flow rate of the gas corresponding to the region A11 smaller than a point M3 corresponds to the first flow rate range corresponding to a third number of rotations. In the fourth characteristic curve T4, the range of the flow rate of the gas corresponding to the region A11 smaller than a point M4 corresponds to the first flow rate range corresponding to a fourth number of rotations.

Moreover, in the first characteristic curve T1, the range of the flow rate of the gas corresponding to the region A12 between the point M1 and a point N1 corresponds to the second flow rate range corresponding to the first number of rotations. In the second characteristic curve T2, the range of the flow rate of the gas corresponding to the region A12 between the point M2 and a point N2 corresponds to the second flow rate range corresponding to the second number of rotations.

In the third characteristic curve T3, the range of the flow rate of the gas corresponding to the region A12 between the point M3 and a point N3 corresponds to the second flow rate range corresponding to the third number of rotations. In the fourth characteristic curve T4, the range of the flow rate of the gas corresponding to the region A12 between the point M4 and a point N4 corresponds to the second flow rate range corresponding to the fourth number of rotations.

Moreover, in the first characteristic curve T1, the range of the flow rate of the gas corresponding to the region A13 between the point N1 and a point C1 corresponds to the third flow rate range corresponding to the first number of rotations. In the second characteristic curve T2, the range of the flow rate of the gas corresponding to the region A13 between the point N2 and a point C2 corresponds to the third flow rate range corresponding to the second number of rotations.

In the third characteristic curve T3, the range of the flow rate of the gas corresponding to the region A13 between the point N3 and a point C3 corresponds to the third flow rate range corresponding to the third number of rotations. In the fourth characteristic curve T4, the range of the flow rate of the gas corresponding to region A13 between the point N4 and a point C4 corresponds to the third flow rate range corresponding to the fourth number of rotations.

Moreover, in the first characteristic curve T1, the range of the flow rate of the gas corresponding to the region A14 between the point C1 and a point D1 corresponds to the fourth flow rate range corresponding to the first number of rotations. In the second characteristic curve T2, the range of the flow rate of the gas corresponding to region A14 between the point C2 and a point D2 corresponds to the fourth flow rate range corresponding to the second number of rotations.

In the third characteristic curve T3, the range of the flow rate of the gas corresponding to region A14 between the point C3 and a point D3 corresponds to the fourth flow rate range corresponding to the third number of rotations. In the fourth characteristic curve T4, the range of the flow rate of the gas corresponding to region A14 between the point C4 and a point D4 corresponds to the fourth flow rate range corresponding to the fourth number of rotations.

Moreover, in the first characteristic curve T1, the range of the flow rate of the gas corresponding to the region A15 between the point D1 and a point S1 corresponds to the fifth flow rate range corresponding to the first number of rotations. In the second characteristic curve T2, the range of the flow rate of the gas corresponding to the region A15 between the point D2 and a point S2 corresponds to the fifth flow rate range corresponding to the second number of rotations.

In the third characteristic curve T3, the range of the flow rate of the gas corresponding to the region A15 between the point D3 and a point S3 corresponds to the fifth flow rate range corresponding to the third number of rotations. In the fourth characteristic curve T4, the range of the flow rate of the gas corresponding to the region A15 between the point D4 and a point S4 corresponds to the fifth flow rate range corresponding to the fourth number of rotations.

Moreover, in the first characteristic curve T1, the range of the flow rate of the gas corresponding to the region A16 larger than the point S1 corresponds to the sixth flow rate range corresponding to the first number of rotations. In the second characteristic curve T2, the range of the flow rate of the gas corresponding to the region A16 larger than the point S2 corresponds to the sixth flow rate range corresponding to the second number of rotations.

In the third characteristic curve T3, the range of the flow rate of the gas corresponding to the region A16 larger than the point S3 corresponds to the sixth flow rate range corresponding to the third number of rotations. In the fourth characteristic curve T4, the range of the flow rate of the gas corresponding to the region A16 larger than the point S4 corresponds to the sixth flow rate range corresponding to the fourth number of rotations.

The six flow rate ranges described above are stored in the storage 21 such that a plurality of sections are determined for the number of rotations of the blower motor 11b and that the six flow rate ranges are associated with the sections, for example.

In the second embodiment, the flow rate controller 22 calculates the actual flow rate of the gas flowing through the gas pipe 10 (hereinafter referred to as the actual flow rate) and determines the manipulated variable of the intake damper 440 and the blower 11, as described below.

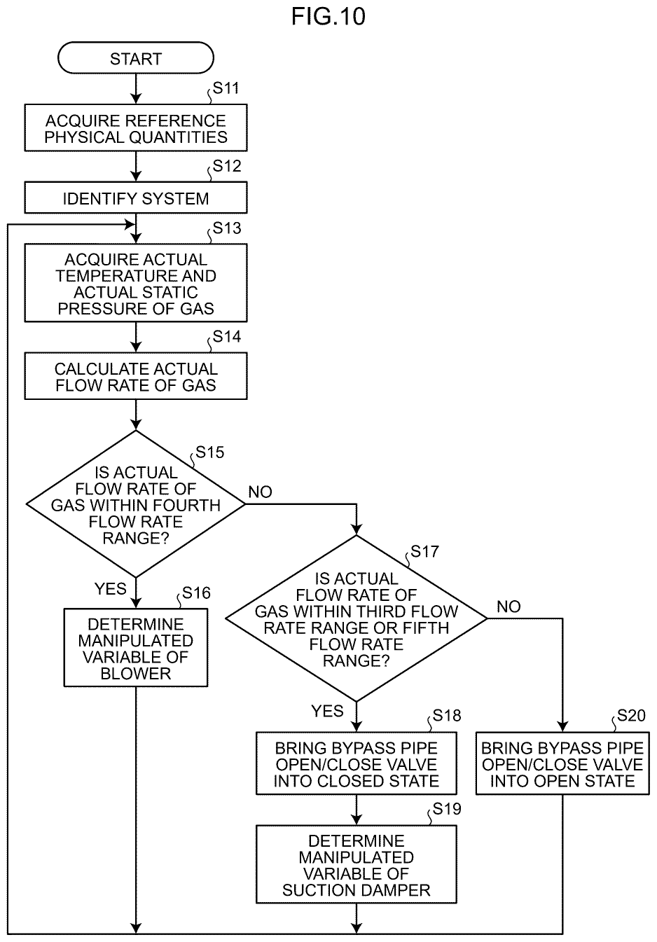

FIG. 10 is a flowchart executed by the flow rate controller 22 illustrated in FIG. 8 to calculate the actual flow rate and determine the manipulated variable of the blower 11 and the manipulated variable of the intake damper 440. The flow rate controller 22 executes the process of the flowchart illustrated in FIG. 10 when the industrial furnace 2 is operating during product manufacturing. Product manufacturing is carried out in one of the industrial furnaces 2. In other words, during product manufacturing, only the open/close valve 10b corresponding to one industrial furnace 2 used for product manufacturing is in the open state, and the gas discharged from the industrial furnace 2 flows through the gas pipe 10. Moreover, at the start of the flowchart illustrated in FIG. 10, the bypass pipe open/close valve 451 is in the closed state. The following describes a case where the open/close valve 10b corresponding to the fourth industrial furnace 2d is in the open state and the gas flows through the fourth system as illustrated in FIG. 8.

At the start of product manufacturing, the flow rate controller 22 sets the degree of opening of the intake damper 440 to a predetermined degree of opening and controls the blower motor 11b of the blower 11 at a predetermined number of rotations. As a result, the gas discharged from the industrial furnace 2 is supplied to the gas treatment apparatus 3 via the gas pipe 10. The predetermined degree of opening and the predetermined number of rotations are, for example, the degree of opening of the intake damper 440 and the number of rotations of the blower motor 11b at which the flow rate of the gas flowing through the gas pipe 10 is smaller than the target flow rate, which will be described later.

The flow rate controller 22 acquires the reference physical quantities at Step S11 in the same manner as that at Step S1 in FIG. 3. Subsequently, at Step S12, the flow rate controller 22 identifies the system through which the gas flows, in the same manner as that at Step S1 in FIG. 3.

The flow rate controller 22 acquires the actual temperature and the actual static pressure of the gas at Step S13 in the same manner as that at Step S3 in FIG. 3. Subsequently, the flow rate controller 22 calculates the actual flow rate of the gas at Step S14 in the same manner as that at Step S4 in FIG. 3.

Furthermore, the flow rate controller 22 determines whether the actual flow rate of the gas is within the fourth flow rate range at Step S15. Specifically, the flow rate controller 22 determines whether the actual flow rate of the gas is within the fourth flow rate range corresponding to the current number of rotations of the blower motor 11b.

When the industrial furnace 2 and the flow rate control system 1 operate properly, the actual flow rate of the gas is within the fourth flow rate range. In this case (Yes at Step S15), the flow rate controller 22 proceeds the computer program process to Step S16.

The flow rate controller 22 determines the manipulated variable of the blower 11 at Step S16. Specifically, the flow rate controller 22 maintains the degree of opening of the intake damper 440 at the predetermined degree of opening and executes the feedback control to determine the number of rotations of the blower motor 11b of the blower 11 so as to make the actual flow rate calculated at Step S14 equal to the target flow rate based on the deviation between the actual flow rate and the target flow rate. In the present embodiment, the feedback control is PID controller (Proportional-Integral-Differential Controller), for example. The manipulated variable of the blower 11 is the number of rotations of the blower motor 11b.

The target flow rate is determined by the product volume and the desulfurization efficiency of the gas treatment apparatus 3 and is input to the control device 20 by the operator in advance. Moreover, the target flow rate is determined within a range corresponding to the region described below with reference to FIG. 9.

The four curves represented by the dashed lines in FIG. 9 correspond to the first resistance curve R1, the second resistance curve R2, the third resistance curve R3, and the fourth resistance curve R4, which are the same as the resistance curves of the respective systems illustrated in FIG. 4.

Moreover, the pipeline resistance of the system increases and the gradient of the resistance curve increases, as the degree of opening of the intake damper 440 decreases. When the gas flows through the fourth system, for example, if the degree of opening of the intake damper 440 decreases and the pipeline resistance of the fourth system increases, the gradient of the fourth resistance curve R4 increases, and thus the fourth resistance curve R4 approaches the third boundary line L13. The first resistance curve R1, the second resistance curve R2, the third resistance curve R3, and the fourth resistance curve R4 illustrated in FIG. 9 indicate the case where the degree of opening of the intake damper 440 is the predetermined degree of opening.

Moreover, FIG. 9 illustrates the intersection of the characteristic curve and the resistance curve illustrated in FIG. 4 (the first operating point OP1, the second operating point OP2, the third operating point OP3, and the fourth operating point OP4), the flow rate of the gas corresponding to the intersection (the first flow rate Q1, the second flow rate Q2, the third flow rate Q3, and the fourth flow rate Q4), and the intake pressure corresponding to the intersection (the first pressure P1, the second pressure P2, the third pressure P3, and the fourth pressure P4).

In the second embodiment, the target flow rate is determined such that the operating point OP is positioned within the range of the flow rate in which what is called a surging phenomenon and a choking phenomenon are suppressed. In other words, the target flow rate is determined such that the operating point OP is positioned within the range of the flow rate corresponding to the region A14 where the operation of the blower 11 is stable and the flow rate increases as the number of rotations of the rotating part 11a increases. In other words, the target flow rate is determined such that the operating point is positioned at a value within the fourth flow rate range.

At Step S16 illustrated in FIG. 10, the flow rate controller 22 maintains the degree of opening of the intake damper 440 at the predetermined degree of opening and determines the number of rotations of the blower motor 11b so as to reduce the deviation between the actual flow rate calculated at Step S14 and the target flow rate. The flow rate controller 22 outputs the determined number of rotations to the blower 11. The blower motor 11b rotates at the output number of rotations, whereby the flow rate (actual flow rate) of the gas flowing through the gas pipe 10 (system) approaches the target flow rate. When the industrial furnace 2 and the flow rate control system 1 operate properly, the actual flow rate of the gas and the intake pressure vary along the resistance curve according to the number of rotations of the blower motor 11b.

When Step S16 is completed, the flow rate controller 22 returns the computer program process to Step S13. Thus, when the industrial furnace 2 and the flow rate control system 1 operate properly during product manufacturing, the flow rate controller 22 repeatedly performs Steps S13, S14, S15, and S16, thereby adjusting the flow rate through the gas pipe 10 so as to make it equal to the target flow rate. As described above, the flow rate control system 1 can accurately regulate the flow rate of the gas flowing through the gas pipe 10 without disposing a measuring instrument or the like in the flow path W of the gas in the gas pipe 10.

On the other hand, if abnormal heat generation occurs in the industrial furnace 2, and the temperature of the gas abnormally rises in the industrial furnace 2, for example, the flow rate of the gas discharged from the industrial furnace 2 rapidly decreases. Specifically, the flow rate of the gas rapidly increases in volumetric flow rate (rapidly decreases in mass flow rate). For example, if the flow rate of the gas is smaller than that corresponding to the point C4 illustrated in FIG. 9 when the number of rotations of the blower motor 11b is the fourth number of rotations, the flow rate of the gas falls outside the fourth flow rate range.

Moreover, if power supply is abnormally stopped in the industrial furnace 2, and the temperature of the gas abnormally drops in the industrial furnace 2, for example, the flow rate of the gas discharged from the industrial furnace 2 rapidly increases. Specifically, the flow rate of the gas rapidly decreases in volumetric flow rate (rapidly increases in mass flow rate). For example, if the flow rate of the gas is larger than that corresponding to the point D4 illustrated in FIG. 9 when the number of rotations of the blower motor 11b is the fourth number of rotations, the flow rate of the gas falls outside the fourth flow rate range.

If the actual flow rate of the gas falls outside the fourth flow rate range (No at Step S15), the flow rate controller 22 determines whether the actual flow rate of the gas is within the third flow rate range or the fifth flow rate range at Step S17.

If the actual flow rate of the gas drops below the fourth flow rate range and falls within the third flow rate range (Yes at Step S17), or if the actual flow rate of the gas exceeds the fourth flow rate range and falls within the fifth flow rate range (Yes at Step S17), the flow rate controller 22 brings the bypass pipe open/close valve 451 into the closed state at Step S18. In other words, the flow rate controller 22 maintains the bypass pipe open/close valve 451 in the closed state.

Subsequently, the flow rate controller 22 determines the manipulated variable of the intake damper 440 at Step S19. Specifically, the flow rate controller 22 maintains the number of rotations of the blower motor 11b at the current number of rotations and determines the manipulated variable of the intake damper 440 such that the actual flow rate calculated at Step S14 falls within the fourth flow rate range. The manipulated variable of the intake damper 440 is the drive amount of the actuator of the intake damper 440. As a result, the degree of opening of the intake damper 440 is adjusted.

For example, if the number of rotations of the blower motor 11b is the fourth number of rotations, and the actual flow rate of the gas is within the third flow rate range (region A13), the operating point corresponding to the actual flow rate of the gas is positioned between the point N4 and the point C4 on the fourth characteristic curve T4. In this case, the flow rate controller 22 determines the manipulated variable of the intake damper 440 so as to make the degree of opening of the intake damper 440 larger than the predetermined degree of opening. When the degree of opening of the intake damper 440 increases, the pipeline resistance of the system decreases (gradient of the resistance curve decreases), the operating point shifts in the direction in which the flow rate of the gas increases along the fourth characteristic curve T4, and the actual flow rate of the gas increases.

By contrast, if the number of rotations of the blower motor 11b is the fourth number of rotations, and the actual flow rate of the gas is within the fifth flow rate range (region A15), the operating point corresponding to the actual flow rate of the gas is positioned between the point D4 and the point S4 on the fourth characteristic curve T4. In this case, the flow rate controller 22 determines the manipulated variable of the intake damper 440 so as to make the degree of opening of the intake damper 440 smaller than the predetermined degree of opening. When the degree of opening of the intake damper 440 decreases, the pipeline resistance of the system increases (gradient of the resistance curve increases), the operating point shifts in the direction in which the flow rate of the gas decreases along the fourth characteristic curve T4, and the actual flow rate of the gas decreases. When Step S19 is completed, the flow rate controller 22 returns the computer program process to Step S13.

As described above, when an abnormality occurs in the industrial furnace 2, and the actual flow rate of the gas falls outside the fourth flow rate range, the flow rate controller 22 repeatedly performs Steps S13, S14, S15, S17, S18, and S19. Thus, the actual flow rate of the gas is adjusted so as to be within the fourth flow rate range. This prevents the actual flow rate of the gas from falling below the first boundary line L11 and exceeding the fifth boundary line L15, thereby inhibiting the occurrence of the surging phenomenon and the choking phenomenon.

While the flow rate controller 22 repeatedly performs Steps S13, S14, S15, S17, S18, and S19, if the actual flow rate of the gas falls within the fourth flow rate range (Yes at Step S15), the flow rate controller 22 repeatedly performs Steps S13, S14, S15, and S16 as described above.

By contrast, while the flow rate controller 22 repeatedly performs Steps S13, S14, S15, S17, S18, and S19, if the actual flow rate of the gas falls within the second flow rate range (region A12), the actual flow rate of the gas falls outside the third flow rate range or the fifth flow rate range. In this case (No at Step S17), the flow rate controller 22 brings the bypass pipe open/close valve 451 into the open state at Step S20.

After the bypass pipe open/close valve 451 is brought into the open state, the gas output from the blower 11 in the gas pipe 10 flows through the bypass pipe 450 from the secondary side of the blower 11 toward the primary side to return to the primary side of the blower 11 and flows into the blower 11. As a result, the actual flow rate of the gas flowing into the blower 11 increases. Therefore, the surging phenomenon is prevented in which the actual flow rate of the gas flowing into the blower 11 decreases with respect to the intake pressure of the blower 11 and the operation state of the blower 11 is unstable. The increment per unit time of the gas flowing into the blower 11 is larger when the bypass pipe open/close valve 451 is in the open state than when the degree of opening of the intake damper 440 is increased by driving the actuator of the intake damper 440. In other words, bringing the bypass pipe open/close valve 451 into the open state increases the actual flow rate of the gas flowing into the blower 11 rapidly.

For example, if the number of rotations of the blower motor 11b is the fourth number of rotations, and the actual flow rate of the gas is within the second flow rate range (region A12), the operating point corresponding to the actual flow rate of the gas is positioned between the point M4 and the point N4 on the fourth characteristic curve T4. In this case, if the bypass pipe open/close valve 451 is brought into the open state, the pipeline resistance of the system rapidly decreases (gradient of the resistance curve rapidly decreases), the operating point shifts in the direction in which the flow rate of the gas increases along the fourth characteristic curve T4, and the actual flow rate of the gas rapidly increases. When Step S20 is completed, the flow rate controller 22 returns the computer program process to Step S13.

As described above, after an abnormality occurs in the industrial furnace 2, and the actual flow rate of the gas falls within the second flow rate range, the flow rate controller 22 repeatedly performs Steps S13, S14, S15, S17, and S20. As a result, the actual flow rate of the gas rapidly increases as described above. Therefore, the actual flow rate of the gas can be further prevented from being smaller than the first boundary line L11, thereby inhibiting the occurrence of the surging phenomenon.

Moreover, while the flow rate controller 22 repeatedly performs Steps S13, S14, S15, S17, and S20, if the actual flow rate of the gas increases, and the flow rate of the gas falls within the third flow rate range (Yes at Step S17), the flow rate controller 22 brings the bypass pipe open/close valve 451 into the closed state at Step S18 and repeatedly performs Steps S13, S14, S15, S17, S18, and S19 as described above. Thus, when the actual flow rate of the gas decreases by adjusting the degree of opening of the intake damper 440, the surging phenomenon can be further suppressed by bringing the bypass pipe open/close valve 451 into the open state.

As described above, the flow rate control system 1 according to the second embodiment includes the gas pipe 10 through which the gas flows, the blower 11 and the intake damper 440 that are disposed in the gas pipe 10 and regulate the flow rate of the gas, the pressure sensor 13 that is disposed on the primary side of the blower 11 and on the primary side of the intake damper 440 in the gas pipe 10 and detects the actual static pressure serving as the actual static pressure of the gas flowing through the gas pipe 10, the temperature sensor 12 that is disposed on the primary side of the blower 11 and on the primary side of the intake damper 440 in the gas pipe 10 and detects the actual temperature serving as the actual temperature of the gas flowing through the gas pipe 10, and the control device 20 that controls the blower 11 and the intake damper 440. The flow rate controller 22 of the control device 20 stores therein in advance the reference density serving as the density for reference, the reference velocity serving as the velocity for reference, the reference static pressure serving as the static pressure for reference, and the reference temperature serving as the temperature for reference determined in advance for the gas, and the fourth flow rate range serving as the range of the flow rate of the gas in which the blower 11 operates properly, calculates the actual flow rate serving as the actual flow rate of the gas flowing through the gas pipe 10 using the actual static pressure, the actual temperature, the reference density, the reference velocity, the reference static pressure, and the reference temperature, and determines the manipulated variable of the blower 11 so as to make the actual flow rate equal to the target flow rate when the actual flow rate is within the fourth flow rate range and determines the manipulated variable of the intake damper 440 such that the actual flow rate falls within the fourth flow rate range when the actual flow rate is outside the fourth flow rate range.

With this configuration, if the actual flow rate falls outside the fourth flow rate range when the flow rate of the gas is regulated within the fourth flow rate range by the blower 11, the intake damper 440 can adjust the flow rate of the gas to bring it back within the fourth flow rate range. This prevents the actual flow rate of the gas from falling below the first boundary line L11 and exceeding the fifth boundary line L15, thereby inhibiting the occurrence of the surging phenomenon and the choking phenomenon.

Moreover, the flow rate control system 1 can calculate the flow rate of the gas flowing through the gas pipe 10 without disposing a measuring instrument or the like in the flow path W in the gas pipe 10 by storing therein in advance the reference density and other data. Moreover, the flow rate control system 1 can calculate the flow rate of the gas flowing through the gas pipe 10 while suppressing the effects of the characteristics (e.g., corrosiveness) of the gas and the inclusions, such as the object to be treated and fly ash. Therefore, the flow rate control system 1 can accurately measure the flow rate of the gas and regulate the flow rate of the gas independently of the properties of the gas.

Furthermore, the flow rate control system 1 does not require a measuring instrument (e.g., impeller flowmeter) in the flow path W to detect the flow rate of the gas as described above. Moreover, the flow rate control system 1 can regulate the flow rate of the gas without using a measuring instrument (e.g., ultrasonic flowmeter) disposed outside the flow path W and capable of detecting the flow rate of the gas. Therefore, the cost of the flow rate control system 1 can be reduced.

The flow rate control system 1 further includes the bypass pipe 450 that couples the primary side of the blower 11 and the primary side of the intake damper 440 to the secondary side of the blower 11 and the secondary side of the intake damper 440 in the gas pipe 10 and through which the gas flows, and the bypass pipe open/close valve 451 that opens and closes the bypass pipe 450. The control device 20 stores therein in advance the second flow rate range in which the flow rate of the gas is smaller than the fourth flow rate range, and brings the bypass pipe open/close valve 451 into the open state when the actual flow rate is outside the fourth flow rate range and decreases to a value within the second flow rate range.

With this configuration, the actual flow rate of the gas can be rapidly increased by bringing the bypass pipe open/close valve 451 into the open state when the actual flow rate of the gas approaches the region A11 illustrated in FIG. 9. Therefore, the actual flow rate of the gas can be further prevented from being smaller than the first boundary line L11, thereby suppressing the occurrence of the surging phenomenon.

Next, the following mainly describes the parts in the flow rate control system 1 according to a first modification of the second embodiment of the present disclosure different from those in the second embodiment described above.

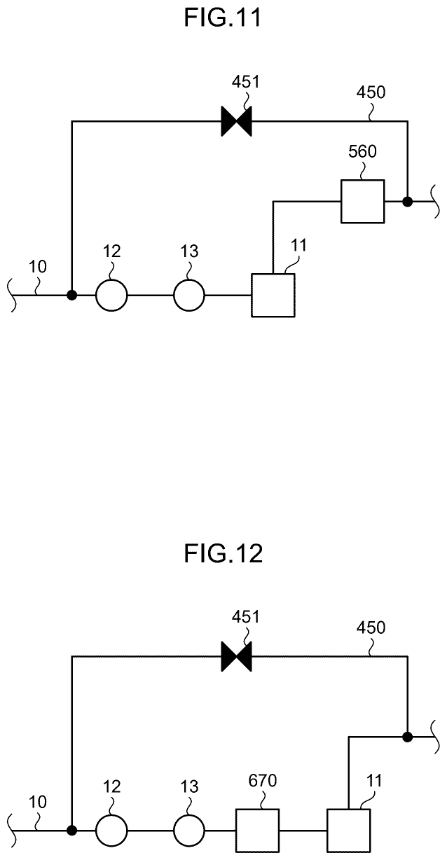

FIG. 11 is a schematic illustrating the configuration of the flow rate control system 1 according to the first modification of the second embodiment of the present disclosure. The flow rate control system 1 illustrated in FIG. 11 includes a discharge damper 560 instead of the intake damper 440. The discharge damper 560 is disposed on the secondary side of the blower 11 in the gas pipe 10. Moreover, in this case, the bypass pipe 450 couples the primary side of the blower 11 and the primary side of the discharge damper 560 to the secondary side of the blower 11 and the secondary side of the discharge damper 560 in the gas pipe 10. In the first modification, the discharge damper 560 corresponds to the “second flow rate adjuster”. In this case, the flow rate controller 22 determines the manipulated variable of the discharge damper 560 (specifically, the drive amount of an actuator that adjusts the degree of opening of the discharge damper 560) such that the actual flow rate calculated at Step S14 falls within the fourth flow rate range at Step S19. In this case, both the intake damper 440 and the discharge damper 560 may be disposed in the gas pipe 10.

Moreover, the flow rate control system 1 does not necessarily include the bypass pipe 450 or the bypass pipe open/close valve 451. In this case, the flow rate controller 22 does not perform Steps S17, S18, and S20 illustrated in FIG. 10.

Moreover, the storage 21 may store therein in advance expressions indicating the boundary lines L11, L12, L13, L14, and L15 illustrated in FIG. 9 and the correlation between the static pressure detected by the pressure sensor 13 and the intake pressure illustrated in FIG. 9. In this case, at Step S15, the flow rate controller 22 may calculate the fourth flow rate range corresponding to the actual static pressure acquired at Step S13 using the expressions indicating the boundary lines L13 and L14 and determine whether the actual flow rate calculated at Step S14 is within the fourth flow rate range. Similarly, at Step S17, the flow rate controller 22 may calculate the third flow rate range and the fifth flow rate range corresponding to the actual static pressure acquired at Step S11 using the expressions indicating the boundary lines L12, L13, L14, and L15 and determine whether the actual flow rate calculated at Step S14 is within the third flow rate range or the fifth flow rate range.

Moreover, at Step S16, the flow rate controller 22 may maintain the number of rotations of the blower motor 11b at the predetermined number of rotations and determine the manipulated variable of the intake damper 440 (drive amount of the actuator of the intake damper 440) so as to make the actual flow rate calculated at Step S14 equal to the target flow rate based on the deviation between the actual flow rate and the target flow rate. In other words, the intake damper 440 in this case corresponds to the “first flow rate adjuster”. Moreover, in this case, the fourth flow rate range is the range of the flow rate of the gas in which the intake damper 440 operates properly. In other words, the fourth flow rate range is the range in which the flow rate of the gas varies with the degree of opening of the intake damper 440 and the flow rate increases as the degree of opening of the intake damper 440 increases. Furthermore, in this case, at Step S19, the flow rate controller 22 may maintain the degree of opening of the intake damper 440 at the predetermined degree of opening and determine the manipulated variable of the blower 11 (number of rotations of the blower motor 11b) such that the actual flow rate calculated at Step S14 falls within the fourth flow rate range. In other words, the blower 11 in this case corresponds to the “second flow rate adjuster”.

Next, the following mainly describes the parts in the flow rate control system 1 according to a second modification of the second embodiment of the present disclosure different from those in the second embodiment described above.

FIG. 12 is a schematic illustrating the configuration of the flow rate control system 1 according to the second modification of the second embodiment of the present disclosure. The flow rate control system 1 illustrated in FIG. 12 includes an inlet guide vane 670 instead of the intake damper 440. In this case, the bypass pipe 450 couples the primary side of the blower 11 and the primary side of the inlet guide vane 670 to the secondary side of the blower 11 and the secondary side of the inlet guide vane 670 in the gas pipe 10. The inlet guide vane 670 includes a plurality of rotatable vanes and an actuator that rotates the vanes. Rotation of the vanes changes the degree of opening of the inlet guide vane 670, thereby changing the flow rate of the gas. In this case, the inlet guide vane 670 corresponds to the “second flow rate adjuster”. The flow rate controller 22 determines the manipulated variable of the inlet guide vane 670 (specifically, the angle of rotation of the vane that adjusts the degree of opening of the inlet guide vane 670 (i.e., the drive amount of the actuator that rotates the vane)) such that the actual flow rate calculated at Step S14 falls within the fourth flow rate range at Step S19. In this case, at least one of the intake damper 440 and the discharge damper 560 may be disposed in the gas pipe 10.

If the actual flow rate of the gas is within the first flow rate range or the sixth flow rate range, the flow rate controller 22 may stop the operation of the intake damper 440 and the blower 11 and terminate the computer program.

Next, the following mainly describes the parts in the flow rate control system 1 according to other modifications of the embodiments of the present disclosure different from those in the embodiments described above.

For example, the temperature sensor 12 may detect the temperature of the outer surface of the gas pipe 10. This configuration can reliably prevent corrosion and damage to the temperature sensor 12.

Moreover, the control device 20 may be capable of changing the gain in PID controller. The gain is input to the control device 20 by the operator, for example. With this configuration, the flow rate controller 22 can determine the manipulated variable such that the amount of change in the flow rate of the gas is an appropriate amount.

The storage 21 may store therein expressions mathematically equivalent to Expressions (1), (2), (3), (4), (5), and (6) above. For example, the storage 21 stores therein Expressions (1), (2), (3), (4A), (4B), (5), and (6) below. In this case, the flow rate controller 22 calculates the actual flow rate (Gw) using Expressions (1), (2), (3), (4A), (4B), (5), and (6) as in the embodiment above.

$${PT}_{0} = {PS}_{0} + {PD}_{0} \qquad ( 1 )$$

$${PD}_{0} = ( {ρ}_{0} \times {V}_{0}^{2} / 2 ) \times {10}^{- 3} \qquad ( 2 )$$

$${PS}_{1}^{′} = {PS}_{1} \times ( 273.15 + {T}_{1} ) / ( 273.15 + {T}_{0} ) \qquad ( 3 )$$

$${PT}_{1}^{′} = {PS}_{1}^{′} + {PD}_{1}^{′} \qquad ( 4 A )$$

$${PD}_{1}^{′} = ( {ρ}_{0} \times {V}_{1}^{2} / 2 ) \times {10}^{- 3} \qquad ( 4 B )$$

$${PT}_{1}^{′} = {PT}_{0} \times {( {V}_{1} / {V}_{0} )}^{2} \qquad ( 5 )$$

$$Gw = A \times {V}_{1} \qquad ( 6 )$$

In Expression (4A), PD₁′ is a value obtained by adjusting the actual velocity pressure (unit: kPa), which is the actual velocity pressure of the gas, to the conditions of the reference temperature. Expression (4A) indicates that the sum of the adjusted actual static pressure (PS₁′) and the adjusted actual velocity pressure (PD₁′) is the adjusted actual total pressure (PT₁′).

Similarly to Expression (2), Expression (4B) is an expression indicating the kinetic energy of the gas in the unit of pressure and is derived based on Bernoulli's principle.

Moreover, the flow rate controller 22 may adjust the calculated actual flow rate (Gw) to a value corresponding to standard conditions. Specifically, the flow rate controller 22 adjusts the actual flow rate based on Expressions (7), (8), and (9) below also stored in the storage 21.

$${C}_{1} = ( 273.15 ) / ( 273.15 + {T}_{1} ) \qquad ( 7 )$$

$${C}_{2} = ( 101.325 + {PS}_{1} ) / 101.325 \qquad ( 8 )$$

$${Gw}^{′} = Gw \times {C}_{1} \times {C}_{2} \qquad ( 9 )$$

In Expression (7), C1 is the adjustment coefficient for temperature. In Expression (8), C2 is the adjustment coefficient for static pressure. In Expression (9), Gw′ is a value obtained by adjusting the actual flow rate (Gw) to the standard conditions of the gas.

Next, the following mainly describes the parts in the flow rate control system 1 according to another modification of the embodiments of the present disclosure different from those in the embodiments described above.

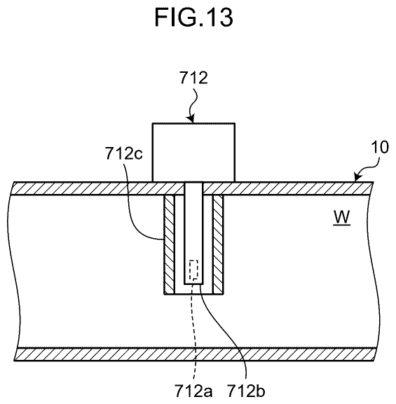

FIG. 13 is a schematic illustrating a temperature sensor 712 of the flow rate control system 1 according to another modification of the embodiments of the present disclosure.

The temperature sensor 712 according to the other modification includes a protrusion 712b positioned in the flow path W. A temperature detector 712a of the temperature sensor 712 is housed in the protrusion 712b. In other words, the temperature detector 712a according to the other modification is disposed in the flow path W. The velocity of the gas decreases toward the outer side in the radial direction of the gas pipe 10. In other words, the temperature detector 712a is disposed in the flow path W, thereby readily detecting a change in temperature of the gas. Therefore, the thermal response of the flow rate control system 1 can be improved when the temperature detector 712a is disposed in the flow path W compared with when the temperature detector 712a is disposed outside the flow path W.

Moreover, the flow rate control system 1 according to the other modification further includes a protective cover 712c. The protective cover 712c covers the protrusion 712b and protects the protrusion 712b and the temperature detector 712a in the flow path W. The protective cover 712c has a cylindrical shape, for example, and is detachable from the gas pipe 10.

The protective cover 712c prevents the inclusions of the gas from coming into direct contact with the protrusion 712b. Thus, the protective cover 712c prevents the protrusion 712b from being worn and the protrusion 712b and the temperature detector 712a from being damaged by the inclusions of the gas. Therefore, the flow rate control system 1 according to the present fourth modification can accurately measure the flow rate of the gas and regulate the flow rate of the gas even when the temperature detector 712a is disposed in the flow path W.

Moreover, the gas discharged from the industrial furnace 2 may contain nitrogen (specifically, nitrogen oxides: e.g., nitrogen dioxide). If the gas contains nitrogen oxides, the gas treatment apparatus 3 may be a denitration apparatus that removes nitrogen oxides. If the gas treatment apparatus 3 is a denitration apparatus, the target flow rate described above may be determined by the denitration efficiency of the gas treatment apparatus 3 or other factors.

Moreover, the gas discharged from the industrial furnace 2 may contain carbon (specifically carbon oxides: e.g., carbon dioxide). If the gas contains carbon oxides, the gas treatment apparatus 3 may be a recovery apparatus that separates and recovers carbon oxides. If the gas treatment apparatus 3 is a recovery apparatus, the target flow rate described above may be determined by the recovery efficiency of the gas treatment apparatus 3 or other factors.

The gas may contain at least one of sulfur oxides, nitrogen oxides, and carbon oxides. Moreover, the gas treatment apparatus 3 may include an apparatus corresponding to the oxides contained in the gas, including sulfur oxides, nitrogen oxides, and carbon oxides, out of three apparatuses of the desulfurization apparatus, the denitration apparatus, and the recovery apparatus.

According to the present modification, the gas contains nitrogen. The gas pipe 10 connects the industrial furnace 2 that discharges the gas and the gas treatment apparatus 3 (denitration apparatus) that denitrates the gas. With this configuration, the flow rate control system 1 can accurately regulate the flow rate of the gas even if the gas contains nitrogen (nitrogen compounds) and the gas pipe 10 connects the industrial furnace 2 that discharges the gas and the denitration apparatus that denitrates the gas.

Moreover, the gas contains carbon. The gas pipe 10 connects the industrial furnace 2 that discharges the gas and the gas treatment apparatus 3 (recovery apparatus) that recovers carbon oxides.

With this configuration, the flow rate control system 1 can accurately regulate the flow rate of the gas even if the gas contains carbon (carbon oxides) and the gas pipe 10 connects the industrial furnace 2 that discharges the gas and the recovery apparatus that recovers carbon (carbon oxides).

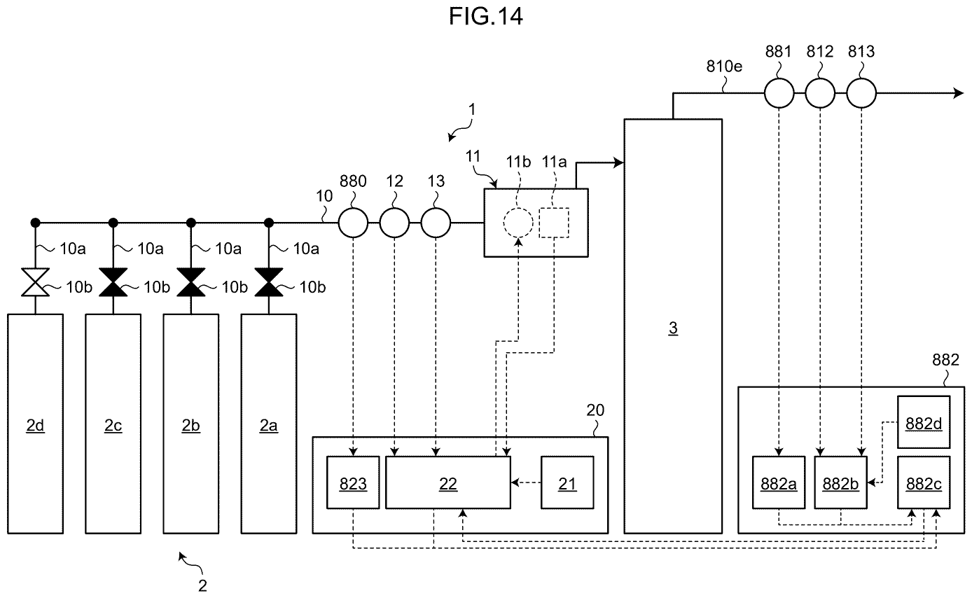

FIG. 14 is a diagram illustrating the configuration of the flow rate control system 1 according to another modification of the embodiments of the present disclosure. While the flow rate control system 1 according to the modification illustrated in FIG. 14 indicates a modification of the flow rate control system 1 according to the first embodiment, the same applies to a modification of the flow rate control system 1 according to the second embodiment.

The flow rate control system 1 according to the present modification further includes a gas sensor 880 and an acquirer 823 included in the control device 20. The gas sensor 880 is disposed on the primary side of the blower 11 in the gas pipe 10 and detects the concentration of sulfur oxides contained in the gas. The gas sensor 880 is a sulfur dioxide sensor that detects sulfur dioxide, for example. The concentration of sulfur oxides detected by the gas sensor 880 is output to the acquirer 823.

Moreover, the flow rate control system 1 according to the present modification further includes a discharge pipe 810e, a second gas sensor 881, a second temperature sensor 812, a second pressure sensor 813, and an arithmetic device 882. The discharge pipe 810e discharges, to the atmosphere, the gas output from the gas treatment apparatus 3. The second gas sensor 881, the second temperature sensor 812, and the second pressure sensor 813 are disposed in the discharge pipe 810e.

The second gas sensor 881 is configured in the same manner as the gas sensor 880 and detects the concentration of sulfur oxides contained in the gas flowing through the discharge pipe 810e. In other words, the second gas sensor 881 detects the concentration of sulfur oxides contained in the gas treated by the gas treatment apparatus 3 (hereinafter referred to as the gas after treatment). The second gas sensor 881 is a sulfur dioxide sensor that detects sulfur dioxide, for example. The gas sensor 880 and the second gas sensor 881 may be gas chromatographs capable of detecting sulfur oxides.

The second temperature sensor 812 detects the temperature of the gas after treatment. The second pressure sensor 813 detects the static pressure of the gas after treatment. Similarly to the temperature sensor 12 and pressure sensor 13 according to the embodiment described above, the second temperature sensor 812 and the second pressure sensor 813 are disposed on the discharge pipe 810e with a branch pipe interposed therebetween.

The temperature detected by the second temperature sensor 812 and the static pressure detected by the second pressure sensor 813 are output to the arithmetic device 882.

The arithmetic device 882 includes an acquirer 882a, a flow rate calculator 882b, an efficiency calculator 882c, and a storage 882d.

The acquirer 882a acquires the detection value of the second gas sensor 881 and outputs the detection value to the efficiency calculator 882c.

The flow rate calculator 882b calculates the actual flow rate of the gas after treatment based on the detected value of the second temperature sensor 812 and the detection value of the second pressure sensor 813 in the same manner as the flow rate controller 22 according to the embodiments described above. The storage 882d stores therein the reference density, the reference velocity, the reference static pressure, and the reference temperature corresponding to the gas after treatment and Expressions (1), (2), (3), (4), (5), and (6) above.

The efficiency calculator 882c calculates the desulfurization efficiency of the gas treatment apparatus 3. The efficiency calculator 882c acquires the concentration of sulfur oxides contained in the gas flowing through the gas pipe 10 (hereinafter referred to as the gas before treatment) and the actual flow rate of the gas before treatment from the acquirer 823 and the flow rate controller 22 of the control device 20. The efficiency calculator 882c calculates the flow rate of sulfur oxides contained in the gas before treatment from the concentration of sulfur oxides and the actual flow rate.

Moreover, the efficiency calculator 882c acquires the concentration of sulfur oxides contained in the gas after treatment and the actual flow rate of the gas after treatment from the acquirer 882a and the flow rate calculator 882b. The efficiency calculator 882c calculates the flow rate of sulfur oxides contained in the gas after treatment from the concentration of sulfur oxides and the actual flow rate.

Furthermore, the efficiency calculator 882c calculates the ratio of the amount of sulfur oxides removed by the gas treatment apparatus 3 per unit time to the flow rate of sulfur oxides contained in the gas before treatment (i.e., desulfurization efficiency) based on the flow rate of sulfur oxides contained in the gas before treatment and the flow rate of sulfur oxides contained in the gas after treatment. The arithmetic device 882 may display the calculated desulfurization efficiency on a display unit. This configuration enables a user to monitor the desulfurization efficiency during operation of the flow rate control system 1.

The flow rate controller 22 of the control device 20 may adjust the target flow rate based on the calculated desulfurization efficiency. Moreover, the arithmetic device 882 may adjust the actual flow rate of the gas before treatment and the actual flow rate of the gas after treatment to values corresponding to the standard conditions based on Expressions (7), (8), and (9) above. Furthermore, the control device 20 and the arithmetic device 882 may be integrated.

Moreover, the gas before treatment may contain at least one oxide of sulfur (specifically sulfur oxides), nitrogen (specifically nitrogen oxides), and carbon (specifically carbon oxides). If the gas before treatment contains nitrogen oxides, the gas treatment apparatus 3 may include a denitration apparatus that removes nitrogen oxides. If the gas before treatment contains carbon oxides, the gas treatment apparatus 3 may include a recovery apparatus that separates and recovers carbon oxides.

Moreover, if the gas treatment apparatus 3 includes a denitration apparatus, the gas sensor 880 and the second gas sensor 881 may detect nitrogen oxides. In this case, the gas sensor 880 and the second gas sensor 881 include a graphene gas sensor that detects nitrogen dioxides, for example. In this case, the gas sensor 880 and the second gas sensor 881 may be gas chromatographs capable of detecting nitrogen oxides.

Moreover, in this case, the acquirer 823 of the control device 20 acquires the concentration of nitrogen oxides contained in the gas before treatment, and the acquirer 882a of the arithmetic device 882 acquires the concentration of nitrogen oxides contained in the gas after treatment.

Furthermore, in this case, the efficiency calculator 882c may calculate the flow rate of nitrogen oxides contained in the gas before treatment and the flow rate of nitrogen oxides contained in the gas after treatment and calculate the ratio of the amount of nitrogen oxides removed by the gas treatment apparatus 3 per unit time to the flow rate of nitrogen oxides contained in the gas before treatment (i.e., denitration efficiency). The arithmetic device 882 may display the calculated denitration efficiency on the display unit. This configuration enables the user to monitor the denitration efficiency during operation of the flow rate control system 1.

Moreover, if the gas treatment apparatus 3 includes a recovery apparatus, the gas sensor 880 and the second gas sensor 881 may detect carbon oxides. In this case, the gas sensor 880 and the second gas sensor 881 include a graphene gas sensor that detects carbon dioxides, for example. In this case, the gas sensor 880 and the second gas sensor 881 may be gas chromatographs capable of detecting carbon oxides.

Moreover, in this case, the acquirer 823 of the control device 20 acquires the concentration of carbon oxides contained in the gas before treatment, and the acquirer 882a of the arithmetic device 882 acquires the concentration of carbon oxides contained in the gas after treatment.

Furthermore, in this case, the efficiency calculator 882c may calculate the flow rate of carbon oxides contained in the gas before treatment and the flow rate of carbon oxides contained in the gas after treatment and calculate the ratio of the amount of carbon oxides recovered by the gas treatment apparatus 3 per unit time to the flow rate of carbon oxides contained in the gas before treatment (i.e., recovery efficiency). The arithmetic device 882 may display the calculated recovery efficiency on the display unit. This configuration enables the user to monitor the recovery efficiency during operation of the flow rate control system 1.

The target flow rate may be determined by the denitration efficiency and the recovery efficiency of the gas treatment apparatus 3 or other factors. Moreover, the flow rate controller 22 of the control device 20 may adjust the target flow rate based on the calculated desulfurization efficiency, denitration efficiency, and recovery efficiency. The gas treatment apparatus 3 may be an apparatus including at least one of a desulfurization apparatus, a denitration apparatus, and a recovery apparatus.

While exemplary embodiments according to the present disclosure have been described, the present disclosure is not limited to the embodiments. The contents disclosed in the embodiments are given by way of example only, and various modifications can be made without departing from the spirit of the present disclosure. Appropriate modifications made without departing from the spirit of the present disclosure naturally belong to the technical scope of the present disclosure.

The flow rate control system according to the present disclosure can accurately measure the flow rate of gas and regulate the flow rate of the gas independently of inclusions of the gas.

What is claimed is:

1. A flow rate control system comprising:
a gas pipe through which gas flows;
a flow rate adjuster disposed in the gas pipe and configured to adjust a flow rate of the gas;
a pressure sensor disposed on a primary side of the flow rate adjuster in the gas pipe and configured to detect an actual static pressure serving as an actual static pressure of the gas flowing through the gas pipe;
a temperature sensor disposed on the primary side of the flow rate adjuster in the gas pipe and configured to detect an actual temperature serving as an actual temperature of the gas flowing through the gas pipe; and
a control device configured to control the flow rate adjuster, wherein
the control device stores therein in advance a reference density serving as a density for reference, a reference velocity serving as a velocity for reference, a reference static pressure serving as a static pressure for reference, and a reference temperature serving as a temperature for reference determined in advance for the gas,
the control device calculates an actual flow rate serving as an actual flow rate of the gas flowing through the gas pipe using the actual static pressure, the actual temperature, the reference density, the reference velocity, the reference static pressure, and the reference temperature, and
the control device determines a manipulated variable of the flow rate adjuster so as to make the actual flow rate equal to a target flow rate.

2. The flow rate control system according to claim 1,
wherein the control device calculates the actual flow rate using Expressions (1), (2), (3), (4), (5), and (6) below,
$${PT}_{0} = {PS}_{0} + {PD}_{0} \qquad ( 1 )$$
$${PD}_{0} = ( {ρ}_{0} \times {V}_{0}^{2} / 2 ) \times {10}^{- 3} \qquad ( 2 )$$
$${PS}_{1}^{′} = {PS}_{1} \times ( 273.15 + {T}_{1} ) / ( 273.15 + {T}_{0} ) \qquad ( 3 )$$
$${PT}_{1}^{′} = {PS}_{1}^{′} + ( {ρ}_{0} \times {V}_{1}^{2} / 2 ) \times {10}^{- 3} \qquad ( 4 )$$
$${PT}_{1}^{′} = {PT}_{0} \times {( {V}_{1} / {V}_{0} )}^{2} \qquad ( 5 )$$
$$Gw = A \times {V}_{1} \qquad ( 6 )$$
where PT₀ is a reference total pressure (unit: kPa) serving as a total pressure for reference of the gas,
PS₀ is the reference static pressure (unit: kPa),
PD₀ is a reference velocity pressure (unit: kPa) serving as a velocity pressure for reference of the gas,
ρ₀ is the reference density (unit: kg/m³),
V₀ is the reference velocity (unit: m/s),
PS₁ is the actual static pressure (unit: kPa),
T₁ is the actual temperature (unit: ° C.)
T₀ is the reference temperature (unit: ° C.)
PS₁′ is the actual static pressure (unit: kPa) adjusted to a condition of the reference temperature,
PT₁′ is an actual total pressure (unit: kPa) obtained by adjusting an actual total pressure of the gas to a condition of the reference temperature,
V₁ is an actual velocity (unit: m/s) serving as an actual velocity of the gas,
Gw is the actual flow rate (unit: m³/s), and
A is a cross-sectional area (unit: m²) of a flow path of the gas pipe through which the gas flows.

3. The flow rate control system according to claim 1, wherein the pressure sensor is disposed at a portion away from a flow path through which the gas flows in the gas pipe.

4. The flow rate control system according to claim 1, wherein the temperature sensor is disposed at a portion away from a flow path through which the gas flows in the gas pipe.

5. The flow rate control system according to claim 1, wherein
the gas contains sulfur, and
the gas pipe connects an industrial furnace that discharges the gas and a gas treatment apparatus that desulfurizes the gas.

6. The flow rate control system according to claim 1, wherein
the gas contains nitrogen, and
the gas pipe connects an industrial furnace that discharges the gas and a gas treatment apparatus that denitrates the gas.

7. The flow rate control system according to claim 1, wherein
the gas contains carbon, and
the gas pipe connects an industrial furnace that discharges the gas and a gas treatment apparatus that recovers the carbon.

8. A flow rate control method comprising:
detecting an actual static pressure serving as an actual static pressure of gas flowing through a gas pipe and an actual temperature serving as an actual temperature of the gas flowing through the gas pipe, the gas being adjusted by a flow rate adjuster;
calculating an actual flow rate serving as an actual flow rate of the gas, using the actual static pressure and the actual temperature detected at the detecting the actual static pressure and the actual temperature, and a reference density serving as a density for reference, a reference velocity serving as a velocity for reference, a reference static pressure serving as a static pressure for reference, and a reference temperature serving as a temperature for reference determined in advance for the gas; and
determining a manipulated variable of the flow rate adjuster so as to make the actual flow rate calculated at the calculating the actual flow rate equal to a target flow rate.

9. A flow rate control system comprising:
a gas pipe through which gas flows;
a first flow rate adjuster and a second flow rate adjuster disposed in the gas pipe and configured to adjust a flow rate of the gas;
a pressure sensor disposed on a primary side of the first flow rate adjuster and a primary side of the second flow rate adjuster in the gas pipe and configured to detect an actual static pressure serving as an actual static pressure of the gas flowing through the gas pipe;
a temperature sensor disposed on the primary side of the first flow rate adjuster and the primary side of the second flow rate adjuster in the gas pipe and configured to detect an actual temperature serving as an actual temperature of the gas flowing through the gas pipe; and
a control device configured to control the first flow rate adjuster and the second flow rate adjuster, wherein
the control device stores therein in advance a reference density serving as a density for reference, a reference velocity serving as a velocity for reference, a reference static pressure serving as a static pressure for reference, and a reference temperature serving as a temperature for reference determined in advance for the gas, and a normal flow rate range serving as a range of the flow rate of the gas in which the first flow rate adjuster operates properly,
the control device calculates an actual flow rate serving as an actual flow rate of the gas flowing through the gas pipe, using the actual static pressure, the actual temperature, the reference density, the reference velocity, the reference static pressure, and the reference temperature,
the control device determines a manipulated variable of the first flow rate adjuster so as to make the actual flow rate equal to a target flow rate when the actual flow rate is within the normal flow rate range, and
the control device determines a manipulated variable of the second flow rate adjuster such that the actual flow rate falls within the normal flow rate range when the actual flow rate is outside the normal flow rate range.

10. The flow rate control system according to claim 9, further comprising:
a bypass pipe that couples the primary side of the first flow rate adjuster and the primary side of the second flow rate adjuster to a secondary side of the first flow rate adjuster and a secondary side of the second flow rate adjuster in the gas pipe, and through which the gas flows; and
an open/close valve configured to open and close the bypass pipe, wherein
the control device stores therein in advance a predetermined flow rate range in which the flow rate of the gas is smaller than the normal flow rate range, and
the control device brings the open/close valve into an open state when the actual flow rate is outside the normal flow rate range and decreases to a value within the predetermined flow rate range.

11. A flow rate control method comprising:
detecting an actual static pressure serving as an actual static pressure of gas flowing through a gas pipe and an actual temperature serving as an actual temperature of the gas in the gas flowing through the gas pipe and the flow rate of which is adjusted by a first flow rate adjuster and a second flow rate adjuster;
calculating an actual flow rate serving as an actual flow rate of the gas using the actual static pressure and the actual temperature detected at the detecting the actual static pressure and the actual temperature, and a reference density serving as a density for reference, a reference velocity serving as a velocity for reference, a reference static pressure serving as a static pressure for reference, and a reference temperature serving as a temperature for reference determined in advance for the gas;
determining whether the actual flow rate calculated at the calculating the actual flow rate is within a normal flow rate range serving as a range of the flow rate of the gas in which the first flow rate adjuster operates properly;
determining a manipulated variable of the first flow rate adjuster so as to make the actual flow rate equal to a target flow rate when it is determined that the actual flow rate is within the normal flow rate range at the determining whether the actual flow rate is within the normal flow rate range; and
determining a manipulated variable of the second flow rate adjuster such that the actual flow rate falls within the normal flow rate range when it is determined that the actual flow rate is outside the normal flow rate range at the determining whether the actual flow rate is within the normal flow rate range.
